(19) United States
(12) Patent Application Publication
(10) Pub. No.: US 2021/0379547 A1
(43) Pub. Date: Dec. 9, 2021

(54) ULTRAFINE BUBBLE GENERATING APPARATUS, ULTRAFINE BUBBLE GENERATING METHOD, ULTRAFINE BUBBLE-CONTAINING LIQUID, AND STORAGE MEDIUM

(71) Applicant: CANON KABUSHIKI KAISHA, Tokyo (JP)

(72) Inventors: Akitoshi Yamada, Kanagawa (JP); Masahiko Kubota, Tokyo (JP); Yoshiyuki Imanaka, Kanagawa (JP); Yumi Yanai, Kanagawa (JP); Hiroshi Arimizu, Chiba (JP); Hiroyuki Ishinaga, Tokyo (JP); Teruo Ozaki, Kanagawa (JP)

(21) Appl. No.: 17/407,932

(22) Filed: Aug. 20, 2021

Related U.S. Application Data
(63) Continuation of application No. PCT/JP2019/050972, filed on Dec. 25, 2019.

(30) Foreign Application Priority Data
Feb. 28, 2019 (JP) 2019-036144

(51) Int. Cl. B01F 15/06; B01F 15/00; B01F 5/10; B01F 3/04; D06F 39/08; D06F 33/34; D06F 39/04

(52) U.S. Cl. CPC B01F 15/066; B01F 15/00402; B01F 15/0022; B01F 15/00285; B01F 15/00149; D06F 2105/02; B01F 3/04106; D06F 39/088; D06F 33/34; D06F 39/04; B01F 2215/008; B01F 5/10

(57) ABSTRACT

Provided is a UFB generating apparatus that is capable of efficiently generating a UFB-containing liquid with high purity by controlling generation of UFBs in the liquid. A UFB generating apparatus includes a driving unit that drives a heating element included in a heating unit to generate film boiling in the liquid in contact with the heating element, and a control unit that controls driving conditions of the heating element by the driving unit.

### CROSS-REFERENCE TO RELATED APPLICATION

This application is a Continuation of International Patent Application No. PCT/JP2019/050972, filed Dec. 25, 2019, which claims the benefit of Japanese Patent Application No. 2019-036144 filed Feb. 28, 2019, both of which are hereby incorporated by reference herein in their entirety.

### BACKGROUND OF THE INVENTION

### Field of the Invention

The present invention relates to a generating apparatus for ultrafine bubbles smaller than 1.0 μm in diameter, an ultrafine bubble generating method, and an ultrafine bubble-containing liquid.

### Background Art

Recently, there have been developed techniques for applying the features of fine bubbles such as microbubbles in micrometer-size in diameter and nanobubbles in nanometer-size in diameter. Especially, the utility of ultrafine bubbles (hereinafter also referred to as “UFBs”) smaller than 1.0 μm in diameter have been confirmed in various fields.

In PTL 1, a fine air bubble generating apparatus that generates fine bubbles by ejecting from a depressurizing nozzle a pressurized liquid in which a gas is pressurized and dissolved is disclosed. In PTL 2, an apparatus that generates fine bubbles by repeating separating and converging of flows of a gas-mixed liquid with a mixing unit is disclosed.

### CITATION LIST

### Patent Literature

PTL 1: Japanese Patent No. 6118544

PTL 2: Japanese Patent No. 4456176

### SUMMARY OF THE INVENTION

Both the apparatuses described in PTLs 1 and 2 generate not only the UFBs of nanometer-size in diameter but also relatively a large number of milli-bubbles of millimeter-size in diameter and microbubbles of micrometer-size in diameter. Among the above bubbles, the UFBs are suitable for long-term storage since they are less likely to be affected by the buoyancy and thus float in the liquid with Brownian motion. However, in a case where the UFBs are generated with the milli-bubbles and the microbubbles, the UFBs are affected by the disappearance of the milli-bubbles and the microbubbles and decreased over time. For this reason, there has been demanded to generate the UFBs having the high usability at a desired concentration; however, since a relatively large amount of the milli-bubbles and the microbubbles are generated by the UFB generating methods described in PTLs 1 and 2, it has been difficult to control the concentration of the UFBs.

Therefore, an object of the present invention is to provide a UFB generating apparatus and a UFB generating method capable of efficiently generating a UFB-containing liquid with high purity by controlling generation of the UFBs in the liquid.

The present invention is an ultrafine bubble generating apparatus, including: a heating unit that includes a heating element arranged in a position in contact with a liquid; a driving unit that drives the heating element to generate film boiling in the liquid; a setting unit that sets a target concentration of ultrafine bubbles to be generated in the liquid; and a control unit that controls driving conditions of the heating element by the driving unit based on the target concentration set by the setting unit.

### Advantageous Effects of Invention

According to the present invention, it is possible to efficiently generate a UFB-containing liquid with high purity by controlling generation of UFBs in the liquid.

Further features of the present invention will become apparent from the following description of exemplary embodiments with reference to the attached drawings.

### BRIEF DESCRIPTION OF THE DRAWINGS

FIG. 1 is a diagram illustrating an example of a UFB generating apparatus;

FIG. 2 is a schematic configuration diagram of a pre-processing unit;

FIGS. 3A and 3B are a schematic configuration diagram of a dissolving unit and a diagram for describing the dissolving states in a liquid;

FIG. 4 is a schematic configuration diagram of a T-UFB generating unit;

FIGS. 5A and 5B are diagrams for describing details of a heating element;

FIGS. 6A and 6B are diagrams for describing the states of film boiling on the heating element;

FIGS. 7A to 7D are diagrams illustrating the states of generation of UFBs caused by expansion of a film boiling bubble;

FIGS. 8A to 8C are diagrams illustrating the states of generation of UFBs caused by shrinkage of the film boiling bubble;

FIGS. 9A to 9C are diagrams illustrating the states of generation of UFBs caused by reheating of the liquid;

FIGS. 10A and 10B are diagrams illustrating the states of generation of UFBs caused by shock waves made by disappearance of the bubble generated by the film boiling;

FIGS. 11A to 11C are diagrams illustrating a configuration example of a post-processing unit;

FIGS. 12A and 12B are diagrams illustrating a schematic configuration of a UFB generating apparatus in this embodiment;

FIG. 13 describes generation operations for the UFBs that is executed in a first embodiment;

FIG. 14 is a diagram illustrating a relationship between estimated generation time for the UFBs and a UFB concentration of a UFB-containing liquid;

FIG. 15 is a diagram illustrating a relationship between estimated generation time for the UFBs and a UFB concentration of the UFB-containing liquid;

FIG. 16 is a flowchart illustrating generation processing for the UFB-containing liquid that is executed in the first embodiment;

FIG. 17 is a diagram illustrating a relationship between estimated generation time for the UFBs and a UFB concentration of the UFB-containing liquid;

FIG. 18 is a flowchart illustrating generation processing for the UFB-containing liquid that is executed in a third embodiment;

FIG. 19 is a diagram illustrating a relationship between UFB generation time and a generated UFB concentration;

FIG. 20 is a flowchart illustrating generation processing for the UFB-containing liquid that is executed in a fourth embodiment;

FIG. 21 is a diagram schematically illustrating a T-UFB generating apparatus that is used as a water purifier;

FIG. 22 is a flowchart illustrating operations of the example illustrated in FIG. 21;

FIG. 23 is a diagram illustrating a T-UFB generating apparatus that is used in a washing machine;

FIG. 24 is a flowchart illustrating operations of the example illustrated in FIG. 23; and

FIG. 25 is a longitudinal sectional side view illustrating a T-UFB generating apparatus in a sixth embodiment.

### DESCRIPTION OF THE EMBODIMENTS

### [Basic Configuration of UFB Generating Apparatus]

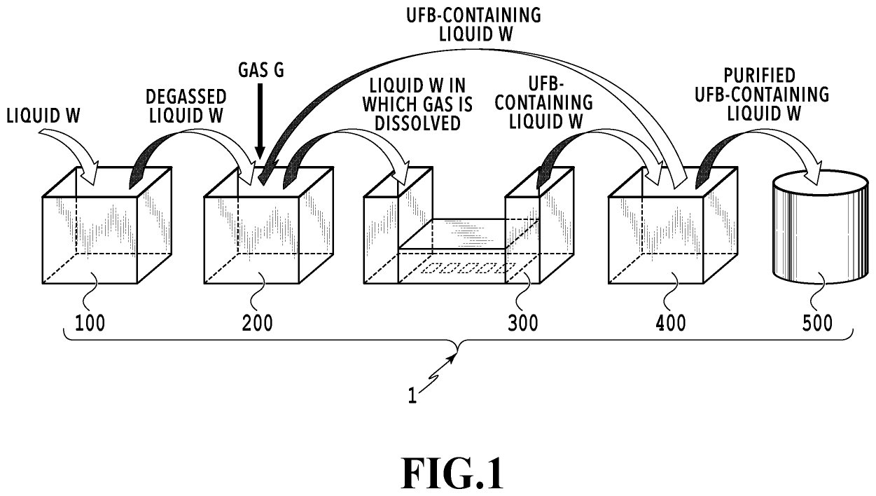

FIG. 1 is a diagram illustrating an example of a basic configuration of an ultrafine bubble generating apparatus (UFB generating apparatus) applicable to the present invention. A UFB generating apparatus 1 of this embodiment includes a pre-processing unit 100, a dissolving unit 200, a T-UFB generating unit 300, a post-processing unit 400, and a collecting unit 500. Processing unique to each unit is performed on a liquid W such as tap water supplied to the pre-processing unit 100 in the above order, and the liquid W is collected as a T-UFB-containing liquid by the collecting unit 500. Hereinafter, functions and configurations of the units are described. A UFB generated by utilizing the film boiling caused by rapid heating is referred to as a thermal-ultra fine bubble (T-UFB) in this specification; details are described later.

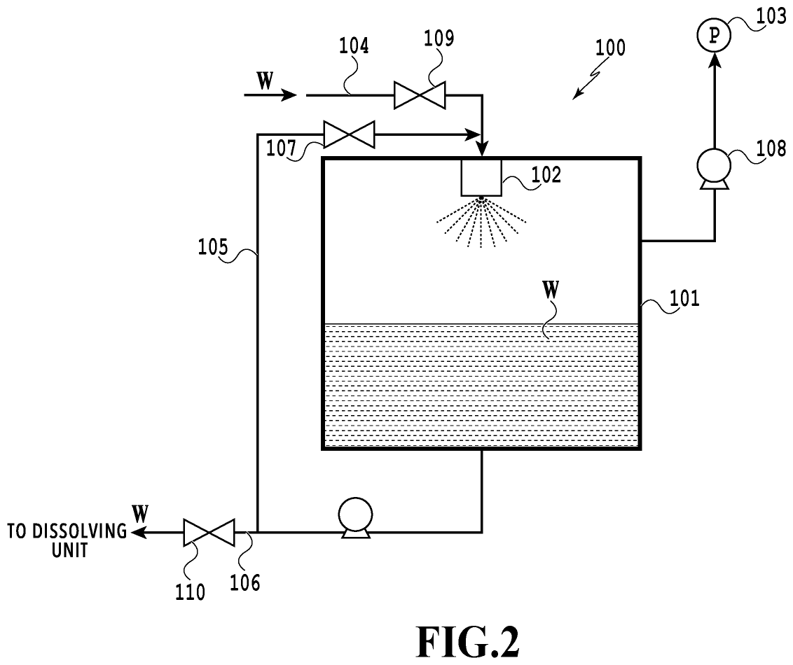

FIG. 2 is a schematic configuration diagram of the pre-processing unit 100. The pre-processing unit 100 of this embodiment performs a degassing treatment on the supplied liquid W. The pre-processing unit 100 mainly includes a degassing container 101, a shower head 102, a depressurizing pump 103, a liquid introduction passage 104, a liquid circulation passage 105, and a liquid discharge passage 106. For example, the liquid W such as tap water is supplied to the degassing container 101 from the liquid introduction passage 104 through a valve 109. In this process, the shower head 102 provided in the degassing container 101 sprays a mist of the liquid W in the degassing container 101. The shower head 102 is for prompting the gasification of the liquid W; however, a centrifugal and the like may be used instead as the mechanism for producing the gasification prompt effect.

When a certain amount of the liquid W is reserved in the degassing container 101 and then the depressurizing pump 103 is activated with all the valves closed, already-gasified gas components are discharged, and gasification and discharge of gas components dissolved in the liquid W are also prompted. In this process, the internal pressure of the degassing container 101 may be depressurized to around several hundreds to thousands of Pa (1.0 Torr to 10.0 Torr) while checking a manometer 108. The gases to be removed by the pre-processing unit 100 includes nitrogen, oxygen, argon, carbon dioxide, and so on, for example.

The above-described degassing processing can be repeatedly performed on the same liquid W by utilizing the liquid circulation passage 105. Specifically, the shower head 102 is operated with the valve 109 of the liquid introduction passage 104 and a valve 110 of the liquid discharge passage 106 closed and a valve 107 of the liquid circulation passage 105 opened. This allows the liquid W reserved in the degassing container 101 and degassed once to be resprayed in the degassing container 101 from the shower head 102. In addition, with the depressurizing pump 103 operated, the gasification processing by the shower head 102 and the degassing processing by the depressurizing pump 103 are repeatedly performed on the same liquid W. Every time the above processing utilizing the liquid circulation passage 105 is performed repeatedly, it is possible to decrease the gas components contained in the liquid W in stages. Once the liquid W degassed to a desired purity is obtained, the liquid W is transferred to the dissolving unit 200 through the liquid discharge passage 106 with the valve 110 opened.

FIG. 2 illustrates the degassing unit 100 that depressurizes the gas part to gasify the solute; however, the method of degassing the solution is not limited thereto. For example, a heating and boiling method for boiling the liquid W to gasify the solute may be employed, or a film degassing method for increasing the interface between the liquid and the gas using hollow fibers. A SEPAREL series (produced by DIC Corporation) is commercially supplied as the degassing module using the hollow fibers. The SEPAREL series uses poly(4-methylpentene-1) (PMP) for the raw material of the hollow fibers and is used for removing air bubbles from ink and the like mainly supplied for a piezo head. In addition, two or more of an evacuating method, the heating and boiling method, and the film degassing method may be used together.

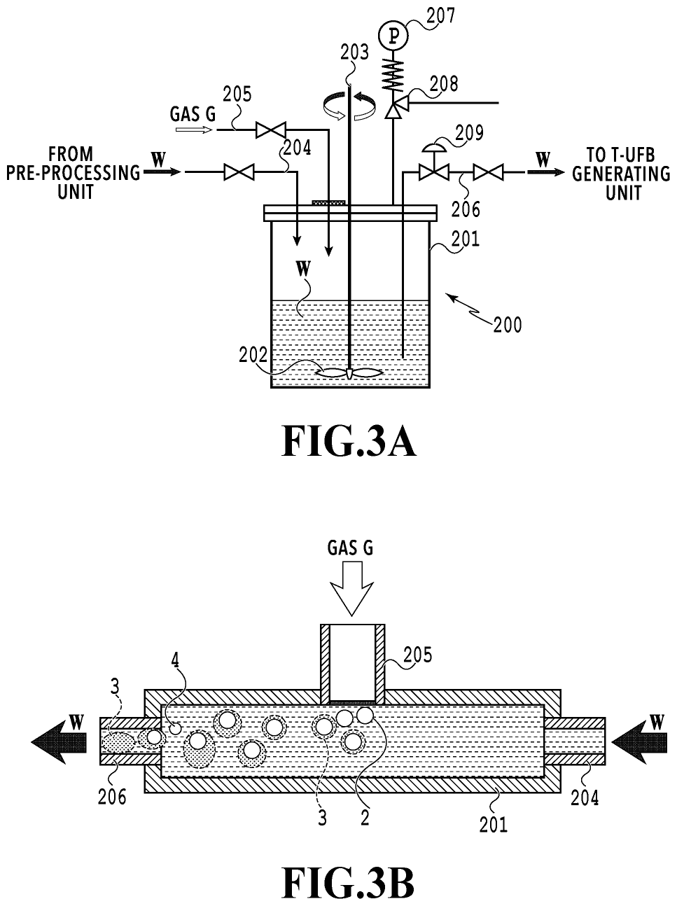

FIGS. 3A and 3B are a schematic configuration diagram of the dissolving unit 200 and a diagram for describing the dissolving states in the liquid. The dissolving unit 200 is a unit for dissolving a desired gas into the liquid W supplied from the pre-processing unit 100. The dissolving unit 200 of this embodiment mainly includes a dissolving container 201, a rotation shaft 203 provided with a rotation plate 202, a liquid introduction passage 204, a gas introduction passage 205, a liquid discharge passage 206, and a pressurizing pump 207.

The liquid W supplied from the pre-processing unit 100 is supplied and reserved into the dissolving container 201 through the liquid introduction passage 204. Meanwhile, a gas G is supplied to the dissolving container 201 through the gas introduction passage 205.

Once predetermined amounts of the liquid W and the gas G are reserved in the dissolving container 201, the pressurizing pump 207 is activated to increase the internal pressure of the dissolving container 201 to about 0.5 MPa. A safety valve 208 is arranged between the pressurizing pump 207 and the dissolving container 201. With the rotation plate 202 in the liquid rotated via the rotation shaft 203, the gas G supplied to the dissolving container 201 is transformed into air bubbles, and the contact area between the gas G and the liquid W is increased to prompt the dissolution into the liquid W. This operation is continued until the solubility of the gas G reaches almost the maximum saturation solubility. In this case, a unit for decreasing the temperature of the liquid may be provided to dissolve the gas as much as possible. When the gas is with low solubility, it is also possible to increase the internal pressure of the dissolving container 201 to 0.5 MPa or higher. In this case, the material and the like of the container need to be the optimum for safety sake.

Once the liquid W in which the components of the gas G are dissolved at a desired concentration is obtained, the liquid W is discharged through the liquid discharge passage 206 and supplied to the T-UFB generating unit 300. In this process, a back-pressure valve 209 adjusts the flow pressure of the liquid W to prevent excessive increase of the pressure during the supplying.

FIG. 3B is a diagram schematically illustrating the dissolving states of the gas G put in the dissolving container 201. An air bubble 2 containing the components of the gas G put in the liquid W is dissolved from a portion in contact with the liquid W. The air bubble 2 thus shrinks gradually, and a gas-dissolved liquid 3 then appears around the air bubble 2. Since the air bubble 2 is affected by the buoyancy, the air bubble 2 may be moved to a position away from the center of the gas-dissolved liquid 3 or be separated out from the gas-dissolved liquid 3 to become a residual air bubble 4. Specifically, in the liquid W to be supplied to the T-UFB generating unit 300 through the liquid discharge passage 206, there is a mix of the air bubbles 2 surrounded by the gas-dissolved liquids 3 and the air bubbles 2 and the gas-dissolved liquids 3 separated from each other.

The gas-dissolved liquid 3 in the drawings means “a region of the liquid W in which the dissolution concentration of the gas G mixed therein is relatively high.” In the gas components actually dissolved in the liquid W, the concentration of the gas components in the gas-dissolved liquid 3 is the highest at a portion surrounding the air bubble 2. In a case where the gas-dissolved liquid 3 is separated from the air bubble 2 the concentration of the gas components of the gas-dissolved liquid 3 is the highest at the center of the region, and the concentration is continuously decreased as away from the center. That is, although the region of the gas-dissolved liquid 3 is surrounded by a broken line in FIG. 3 B for the sake of explanation, such a clear boundary does not actually exist. In addition, in the present invention, a gas that cannot be dissolved completely may be accepted to exist in the form of an air bubble in the liquid.

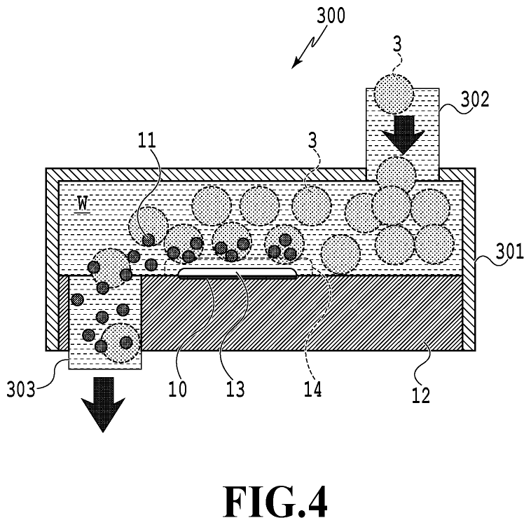

FIG. 4 is a schematic configuration diagram of the T-UFB generating unit 300. The T-UFB generating unit 300 mainly includes a chamber 301, a liquid introduction passage 302, and a liquid discharge passage 303. The flow from the liquid introduction passage 302 to the liquid discharge passage 303 through the chamber 301 is formed by a not-illustrated flow pump. Various pumps including a diaphragm pump, a gear pump, and a screw pump may be employed as the flow pump. In in the liquid W introduced from the liquid introduction passage 302, the gas-dissolved liquid 3 of the gas G put by the dissolving unit 200 is mixed.

An element substrate 12 provided with a heating element 10 is arranged on a bottom section of the chamber 301. With a predetermined voltage pulse applied to the heating element 10, a bubble 13 generated by the film boiling (hereinafter, also referred to as a film boiling bubble 13) is generated in a region in contact with the heating element 10. Then, an ultrafine bubble (UFB) 11 containing the gas G is generated caused by expansion and shrinkage of the film boiling bubble 13. As a result, a UFB-containing liquid W containing many UFBs 11 is discharged from the liquid discharge passage 303.

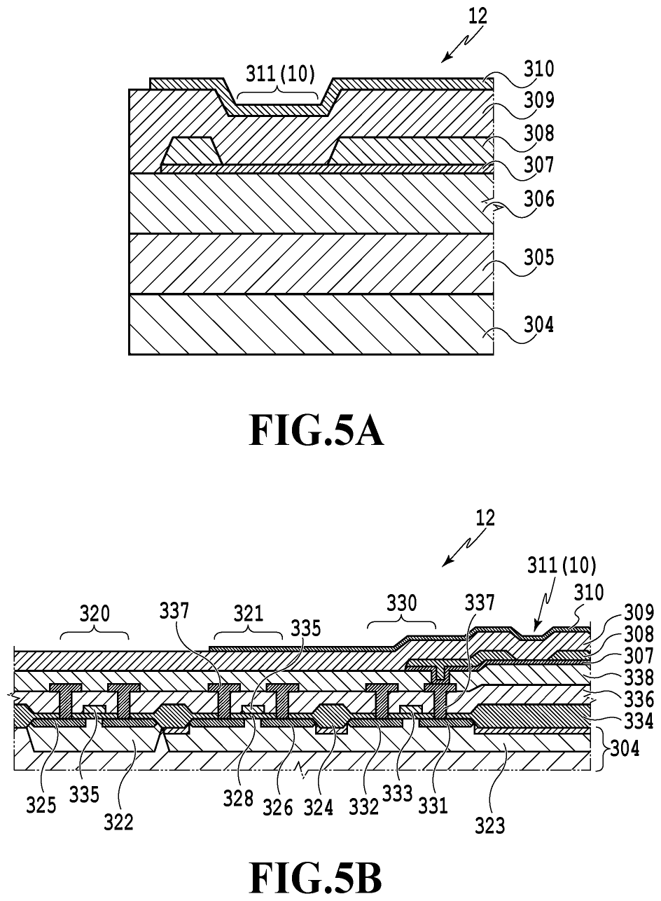

FIGS. 5A and 5B are diagrams for illustrating a detailed configuration of the heating element 10. FIG. 5A illustrates a closeup view of the heating element 10, and FIG. 5B illustrates a cross-sectional view of a wider region of the element substrate 12 including the heating element 10.

As illustrated in FIG. 5A, in the element substrate 12 of this embodiment, a thermal oxide film 305 as a heat-accumulating layer and an interlaminar film 306 also served as a heat-accumulating layer are laminated on a surface of a silicon substrate 304. An SiO₂ film or an SiN film may be used as the interlaminar film 306. A resistive layer 307 is formed on a surface of the interlaminar film 306, and a wiring 308 is partially formed on a surface of the resistive layer 307. An Al-alloy wiring of Al, Al—Si, Al—Cu, or the like may be used as the wiring 308. A protective layer 309 made of an SiO₂ film or an Si₃N₄ film is formed on surfaces of the wiring 308, the resistive layer 307, and the interlaminar film 306.

A cavitation-resistant film 310 for protecting the protective layer 309 from chemical and physical impacts due to the heat evolved by the resistive layer 307 is formed on a portion and around the portion on the surface of the protective layer 309, the portion corresponding to a heat-acting portion 311 that eventually becomes the heating element 10. A region on the surface of the resistive layer 307 in which the wiring 308 is not formed is the heat-acting portion 311 in which the resistive layer 307 evolves heat. The heating portion of the resistive layer 307 on which the wiring 308 is not formed functions as the heating element (heater) 10. As described above, the layers in the element substrate 12 are sequentially formed on the surface of the silicon substrate 304 by a semiconductor production technique, and the heat-acting portion 311 is thus provided on the silicon substrate 304.

The configuration illustrated in the drawings is an example, and various other configurations are applicable. For example, a configuration in which the laminating order of the resistive layer 307 and the wiring 308 is opposite, and a configuration in which an electrode is connected to a lower surface of the resistive layer 307 (so-called a plug electrode configuration) are applicable. In other words, as described later, any configuration may be applied as long as the configuration allows the heat-acting portion 311 to heat the liquid for generating the film boiling in the liquid.

FIG. 5B is an example of a cross-sectional view of a region including a circuit connected to the wiring 308 in the element substrate 12. An N-type well region 322 and a P-type well region 323 are partially provided in a top layer of the silicon substrate 304, which is a P-type conductor. AP-MOS 320 is formed in the N-type well region 322 and an N-MOS 321 is formed in the P-type well region 323 by introduction and diffusion of impurities by the ion implantation and the like in the general MOS process.

The P-MOS 320 includes a source region 325 and a drain region 326 formed by partial introduction of N-type or P-type impurities in a top layer of the N-type well region 322, a gate wiring 335, and so on. The gate wiring 335 is deposited on a part of a top surface of the N-type well region 322 excluding the source region 325 and the drain region 326, with a gate insulation film 328 of several hundreds of A in thickness interposed between the gate wiring 335 and the top surface of the N-type well region 322.

The N-MOS 321 includes the source region 325 and the drain region 326 formed by partial introduction of N-type or P-type impurities in a top layer of the P-type well region 323, the gate wiring 335, and so on. The gate wiring 335 is deposited on a part of a top surface of the P-type well region 323 excluding the source region 325 and the drain region 326, with the gate insulation film 328 of several hundreds of A in thickness interposed between the gate wiring 335 and the top surface of the P-type well region 323. The gate wiring 335 is made of polysilicon of 3000 Å to 5000 Å in thickness deposited by the CVD method. A C-MOS logic is constructed with the P-MOS 320 and the N-MOS 321.

In the P-type well region 323, an N-MOS transistor 330 for driving an electrothermal conversion element (heating resistance element) is formed on a portion different from the portion including the N-MOS 321. The N-MOS transistor 330 includes a source region 332 and a drain region 331 partially provided in the top layer of the P-type well region 323 by the steps of introduction and diffusion of impurities, a gate wiring 333, and so on. The gate wiring 333 is deposited on a part of the top surface of the P-type well region 323 excluding the source region 332 and the drain region 331, with the gate insulation film 328 interposed between the gate wiring 333 and the top surface of the P-type well region 323.

In this example, the N-MOS transistor 330 is used as the transistor for driving the electrothermal conversion element. However, the transistor for driving is not limited to the N-MOS transistor 330, and any transistor may be used as long as the transistor has a capability of driving multiple electrothermal conversion elements individually and can implement the above-described fine configuration. Although the electrothermal conversion element and the transistor for driving the electrothermal conversion element are formed on the same substrate in this example, those may be formed on different substrates separately.

An oxide film separation region 324 is formed by field oxidation of 5000 Å to 10000 Å in thickness between the elements, such as between the P-MOS 320 and the N-MOS 321 and between the N-MOS 321 and the N-MOS transistor 330. The oxide film separation region 324 separates the elements. A portion of the oxide film separation region 324 corresponding to the heat-acting portion 311 functions as a heat-accumulating layer 334, which is the first layer on the silicon substrate 304.

An interlayer insulation film 336 including a PSG film, a BPSG film, or the like of about 7000 Å in thickness is formed by the CVD method on each surface of the elements such as the P-MOS 320, the N-MOS 321, and the N-MOS transistor 330. After the interlayer insulation film 336 is made flat by heat treatment, an Al electrode 337 as a first wiring layer is formed in a contact hole penetrating through the interlayer insulation film 336 and the gate insulation film 328. On surfaces of the interlayer insulation film 336 and the Al electrode 337, an interlayer insulation film 338 including an SiO₂ film of 10000 Å to 15000 Å in thickness is formed by a plasma CVD method. On the surface of the interlayer insulation film 338, a resistive layer 307 including a TaSiN film of about 500 Å in thickness is formed by a co-sputter method on portions corresponding to the heat-acting portion 311 and the N-MOS transistor 330. The resistive layer 307 is electrically connected with the Al electrode 337 near the drain region 331 via a through-hole formed in the interlayer insulation film 338. On the surface of the resistive layer 307, the wiring 308 of Al as a second wiring layer for a wiring to each electrothermal conversion element is formed. The protective layer 309 on the surfaces of the wiring 308, the resistive layer 307, and the interlayer insulation film 338 includes an SiN film of 3000 Å in thickness formed by the plasma CVD method. The cavitation-resistant film 310 deposited on the surface of the protective layer 309 includes a thin film of about 2000 Å in thickness, which is at least one metal selected from the group consisting of Ta, Fe, Ni, Cr, Ge, Ru, Zr, Ir, and the like. Various materials other than the above-described TaSiN such as TaN, CrSiN, TaAl, WSiN, and the like can be applied as long as the material can generate the film boiling in the liquid.

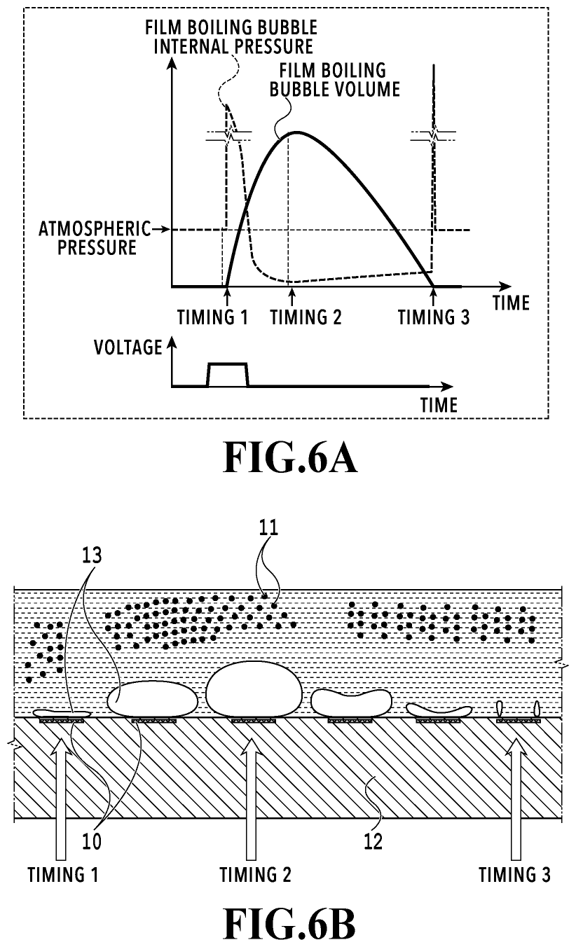

FIGS. 6A and 6B are diagrams illustrating the states of the film boiling when a predetermined voltage pulse is applied to the heating element 10. In this case, the case of generating the film boiling under atmospheric pressure is described. In FIG. 6A, the horizontal axis represents time. The vertical axis in the lower graph represents a voltage applied to the heating element 10, and the vertical axis in the upper graph represents the volume and the internal pressure of the film boiling bubble 13 generated by the film boiling. On the other hand, FIG. 6B illustrates the states of the film boiling bubble 13 in association with timings 1 to 3 shown in FIG. 6A. Each of the states is described below in chronological order. The UFBs 11 generated by the film boiling as described later are mainly generated near a surface of the film boiling bubble 13. The states illustrated in FIG. 6B are the states where the UFBs 11 generated by the generating unit 300 are resupplied to the dissolving unit 200 through the circulation route, and the liquid containing the UFBs 11 is resupplied to the liquid passage of the generating unit 300, as illustrated in FIG. 1.

Before a voltage is applied to the heating element 10, the atmospheric pressure is substantially maintained in the chamber 301. Once a voltage is applied to the heating element 10, the film boiling is generated in the liquid in contact with the heating element 10, and a thus-generated air bubble (hereinafter, referred to as the film boiling bubble 13) is expanded by a high pressure acting from inside (timing 1). A bubbling pressure in this process is expected to be around 8 to 10 MPa, which is a value close to a saturation vapor pressure of water.

The time for applying a voltage (pulse width) is around 0.5 μsec to 10.0 μsec, and the film boiling bubble 13 is expanded by the inertia of the pressure obtained in timing 1 even after the voltage application. However, a negative pressure generated with the expansion is gradually increased inside the film boiling bubble 13, and the negative pressure acts in a direction to shrink the film boiling bubble 13. After a while, the volume of the film boiling bubble 13 becomes the maximum in timing 2 when the inertial force and the negative pressure are balanced, and thereafter the film boiling bubble 13 shrinks rapidly by the negative pressure.

In the disappearance of the film boiling bubble 13, the film boiling bubble 13 disappears not in the entire surface of the heating element 10 but in one or more extremely small regions. For this reason, on the heating element 10, further greater force than that in the bubbling in timing 1 is generated in the extremely small region in which the film boiling bubble 13 disappears (timing 3).

The generation, expansion, shrinkage, and disappearance of the film boiling bubble 13 as described above are repeated every time a voltage pulse is applied to the heating element 10, and new UFBs 11 are generated each time.

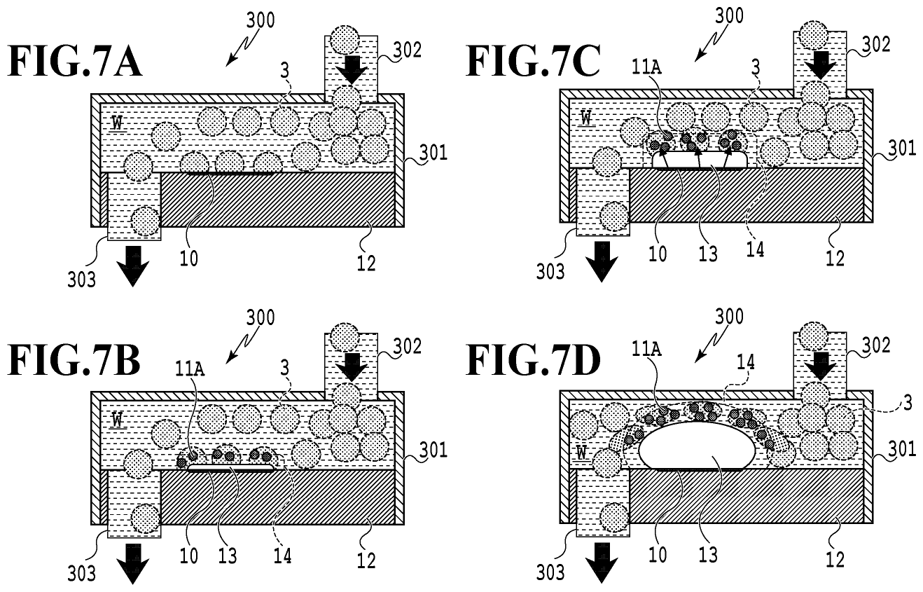

The states of generation of the UFBs 11 in each process of the generation, expansion, shrinkage, and disappearance of the film boiling bubble 13 are further described in detail with reference to FIGS. 7A to 10B.

FIGS. 7A to 7D are diagrams schematically illustrating the states of generation of the UFBs 11 caused by the generation and the expansion of the film boiling bubble 13. FIG. 7A illustrates the state before the application of a voltage pulse to the heating element 10. The liquid W in which the gas-dissolved liquids 3 are mixed flows inside the chamber 301.

FIG. 7B illustrates the state where a voltage is applied to the heating element 10, and the film boiling bubble 13 is evenly generated in almost all over the region of the heating element 10 in contact with the liquid W. When a voltage is applied, the surface temperature of the heating element 10 rapidly increases at a speed of 10° C./μsec. The film boiling occurs at a time point when the temperature reaches almost 300° C., and the film boiling bubble 13 is thus generated.

Thereafter, the surface temperature of the heating element 10 keeps increasing to around 600 to 800° C. during the pulse application, and the liquid around the film boiling bubble 13 is rapidly heated as well. In FIG. 7B, a region of the liquid that is around the film boiling bubble 13 and to be rapidly heated is indicated as a not-yet-bubbling high temperature region 14. The gas-dissolved liquid 3 within the not-yet-bubbling high temperature region 14 exceeds the thermal dissolution limit and is vaporized to become the UFB. The thus-vaporized air bubbles have diameters of around 10 nm to 100 nm and large gas-liquid interface energy. Thus, the air bubbles float independently in the liquid W without disappearing in a short time. In this embodiment, the air bubbles generated by the thermal action from the generation to the expansion of the film boiling bubble 13 are called first UFBs 11A.

FIG. 7C illustrates the state where the film boiling bubble 13 is expanded. Even after the voltage pulse application to the heating element 10, the film boiling bubble 13 continues expansion by the inertia of the force obtained from the generation thereof, and the not-yet-bubbling high temperature region 14 is also moved and spread by the inertia. Specifically, in the process of the expansion of the film boiling bubble 13, the gas-dissolved liquid 3 within the not-yet-bubbling high temperature region 14 is vaporized as a new air bubble and becomes the first UFB 11A.

FIG. 7D illustrates the state where the film boiling bubble 13 has the maximum volume. As the film boiling bubble 13 is expanded by the inertia, the negative pressure inside the film boiling bubble 13 is gradually increased along with the expansion, and the negative pressure acts to shrink the film boiling bubble 13. At a time point when the negative pressure and the inertial force are balanced, the volume of the film boiling bubble 13 becomes the maximum, and then the shrinkage is started.

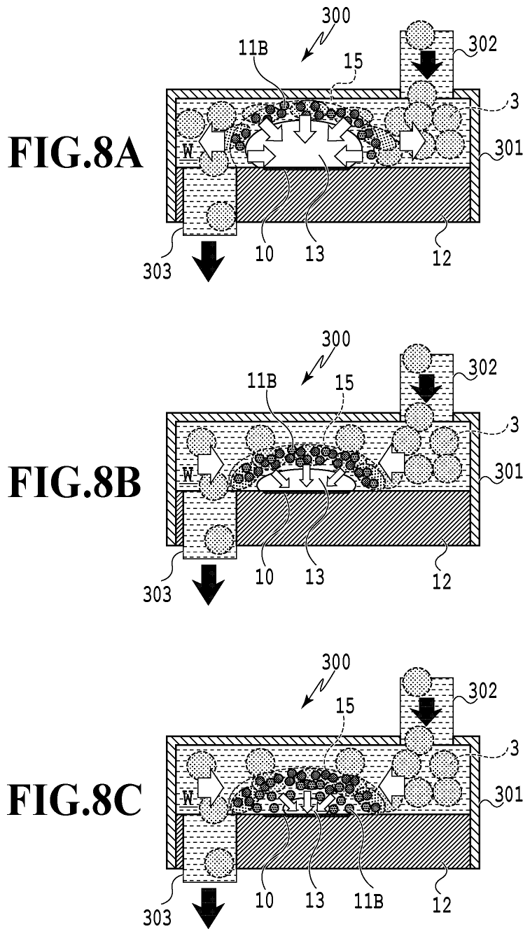

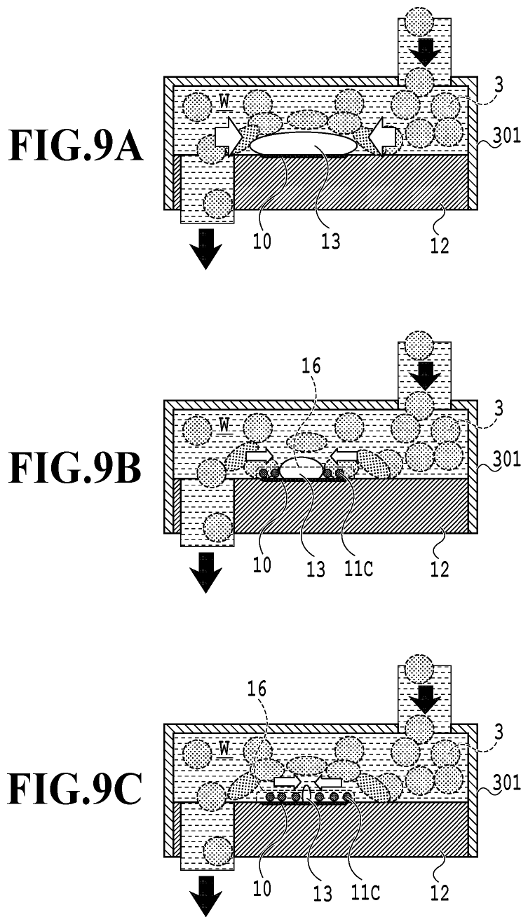

In the shrinking stage of the film boiling bubble 13, there are UFBs generated by the processes illustrated in FIGS. 8A to 8C (second UFBs 11B) and UFBs generated by the processes illustrated in FIGS. 9A to 9C (third UFBs 11C). It is considered that these two processes are made simultaneously.

FIGS. 8A to 8C are diagrams illustrating the states of generation of the UFBs 11 caused by the shrinkage of the film boiling bubble 13. FIG. 8A illustrates the state where the film boiling bubble 13 starts shrinking. Although the film boiling bubble 13 starts shrinking, the surrounding liquid W still has the inertial force in the expansion direction. Because of this, the inertial force acting in the direction of going away from the heating element 10 and the force going toward the heating element 10 caused by the shrinkage of the film boiling bubble 13 act in a surrounding region extremely close to the film boiling bubble 13, and the region is depressurized. The region is indicated in the drawings as a not-yet-bubbling negative pressure region 15.

The gas-dissolved liquid 3 within the not-yet-bubbling negative pressure region 15 exceeds the pressure dissolution limit and is vaporized to become an air bubble. The thus-vaporized air bubbles have diameters of about 100 nm and thereafter float independently in the liquid W without disappearing in a short time. In this embodiment, the air bubbles vaporized by the pressure action during the shrinkage of the film boiling bubble 13 are called the second UFBs 11B.

FIG. 8B illustrates a process of the shrinkage of the film boiling bubble 13. The shrinking speed of the film boiling bubble 13 is accelerated by the negative pressure, and the not-yet-bubbling negative pressure region 15 is also moved along with the shrinkage of the film boiling bubble 13. Specifically, in the process of the shrinkage of the film boiling bubble 13, the gas-dissolved liquids 3 within a part over the not-yet-bubbling negative pressure region 15 are precipitated one after another and become the second UFBs 11B.

FIG. 8C illustrates the state immediately before the disappearance of the film boiling bubble 13. Although the moving speed of the surrounding liquid W is also increased by the accelerated shrinkage of the film boiling bubble 13, a pressure loss occurs due to a flow passage resistance in the chamber 301. As a result, the region occupied by the not-yet-bubbling negative pressure region 15 is further increased, and a number of the second UFBs 11B are generated.

FIGS. 9A to 9C are diagrams illustrating the states of generation of the UFBs by reheating of the liquid W during the shrinkage of the film boiling bubble 13. FIG. 9A illustrates the state where the surface of the heating element 10 is covered with the shrinking film boiling bubble 13.

FIG. 9B illustrates the state where the shrinkage of the film boiling bubble 13 has progressed, and a part of the surface of the heating element 10 comes in contact with the liquid W. In this state, there is heat left on the surface of the heating element 10, but the heat is not high enough to cause the film boiling even if the liquid W comes in contact with the surface. A region of the liquid to be heated by coming in contact with the surface of the heating element 10 is indicated in the drawings as a not-yet-bubbling reheated region 16. Although the film boiling is not made, the gas-dissolved liquid 3 within the not-yet-bubbling reheated region 16 exceeds the thermal dissolution limit and is vaporized. In this embodiment, the air bubbles generated by the reheating of the liquid W during the shrinkage of the film boiling bubble 13 are called the third UFBs 11C.

FIG. 9C illustrates the state where the shrinkage of the film boiling bubble 13 has further progressed. The smaller the film boiling bubble 13, the greater the region of the heating element 10 in contact with the liquid W, and the third UFBs 11C are generated until the film boiling bubble 13 disappears.

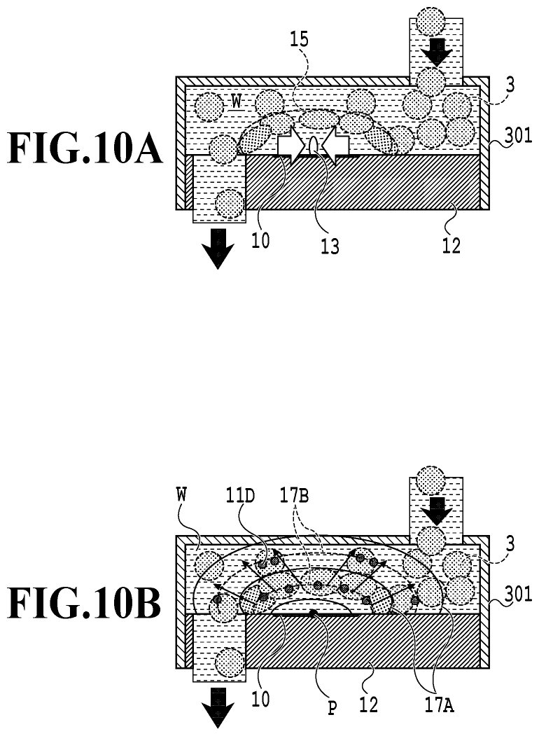

FIGS. 10A and 10B are diagrams illustrating the states of generation of the UFBs caused by an impact from the disappearance of the film boiling bubble 13 generated by the film boiling (that is, a type of cavitation). FIG. 10A illustrates the state immediately before the disappearance of the film boiling bubble 13. In this state, the film boiling bubble 13 shrinks rapidly by the internal negative pressure, and the not-yet-bubbling negative pressure region 15 surrounds the film boiling bubble 13.

FIG. 10B illustrates the state immediately after the film boiling bubble 13 disappears at a point P. When the film boiling bubble 13 disappears, acoustic waves ripple concentrically from the point P as a starting point due to the impact of the disappearance. The acoustic wave is a collective term of an elastic wave that is propagated through anything regardless of gas, liquid, and solid. In this embodiment, compression waves of the liquid W, which are a high pressure surface 17A and a low pressure surface 17B of the liquid W, are propagated alternately.

In this case, the gas-dissolved liquid 3 within the not-yet-bubbling negative pressure region 15 is resonated by the shock waves made by the disappearance of the film boiling bubble 13, and the gas-dissolved liquid 3 exceeds the pressure dissolution limit and the phase transition is made in timing when the low pressure surface 17B passes therethrough. Specifically, a number of air bubbles are vaporized in the not-yet-bubbling negative pressure region 15 simultaneously with the disappearance of the film boiling bubble 13. In this embodiment, the air bubbles generated by the shock waves made by the disappearance of the film boiling bubble 13 are called fourth UFBs 11D.

The fourth UFBs 11D generated by the shock waves made by the disappearance of the film boiling bubble 13 suddenly appear in an extremely short time (1 μS or less) in an extremely narrow thin film-shaped region. The diameter is sufficiently smaller than that of the first to third UFBs, and the gas-liquid interface energy is higher than that of the first to third UFBs. For this reason, it is considered that the fourth UFBs 11D have different characteristics from the first to third UFBs 11A to 11C and generate different effects.

Additionally, the fourth UFBs 11D are evenly generated in many parts of the region of the concentric sphere in which the shock waves are propagated, and the fourth UFBs 11D evenly exist in the chamber 301 from the generation thereof. Although many first to third UFBs already exist in the timing of the generation of the fourth UFBs 11D, the presence of the first to third UFBs does not affect the generation of the fourth UFBs 11D greatly. It is also considered that the first to third UFBs do not disappear due to the generation of the fourth UFBs 11D.

As described above, it is expected that the UFBs 11 are generated in the multiple stages from the generation to the disappearance of the film boiling bubble 13 by the heat generation of the heating element 10. The first UFBs 11A, the second UFBs 11B, and the third UFBs 11C are generated near the surface of the film boiling bubble generated by the film boiling. In this case, near means a region within about 20 μm from the surface of the film boiling bubble. The fourth UFBs 11D are generated in a region through which the shock waves are propagated when the air bubble disappears. Although the above example illustrates the stages to the disappearance of the film boiling bubble 13, the way of generating the UFBs is not limited thereto. For example, with the generated film boiling bubble 13 communicating with the atmospheric air before the bubble disappearance, the UFBs can be generated also if the film boiling bubble 13 does not reach the disappearance.

Next, remaining properties of the UFBs are described. The higher the temperature of the liquid, the lower the dissolution properties of the gas components, and the lower the temperature, the higher the dissolution properties of the gas components. In other words, the phase transition of the dissolved gas components is prompted and the generation of the UFBs becomes easier as the temperature of the liquid is higher. The temperature of the liquid and the solubility of the gas are in the inverse relationship, and the gas exceeding the saturation solubility is transformed into air bubbles and appeared in the liquid as the liquid temperature increases.

Therefore, when the temperature of the liquid rapidly increases from normal temperature, the dissolution properties are decreased without stopping, and the generation of the UFBs starts. The thermal dissolution properties are decreased as the temperature increases, and a number of the UFBs are generated.

Conversely, when the temperature of the liquid decreases from normal temperature, the dissolution properties of the gas are increased, and the generated UFBs are more likely to be liquefied. However, such temperature is sufficiently lower than normal temperature. Additionally, since the once generated UFBs have a high internal pressure and large gas-liquid interface energy even when the temperature of the liquid decreases, it is highly unlikely that there is exerted a sufficiently high pressure to break such a gas-liquid interface. In other words, the once generated UFBs do not disappear easily as long as the liquid is stored at normal temperature and normal pressure.

In this embodiment, the first UFBs 11A described with FIGS. 7A to 7C and the third UFBs 11C described with FIGS. 9A to 9C can be described as UFBs that are generated by utilizing such thermal dissolution properties of gas.

On the other hand, in the relationship between the pressure and the dissolution properties of liquid, the higher the pressure of the liquid, the higher the dissolution properties of the gas, and the lower the pressure, the lower the dissolution properties. In other words, the phase transition to the gas of the gas-dissolved liquid dissolved in the liquid is prompted and the generation of the UFBs becomes easier as the pressure of the liquid is lower. Once the pressure of the liquid becomes lower than normal pressure, the dissolution properties are decreased instantly, and the generation of the UFBs starts. The pressure dissolution properties are decreased as the pressure decreases, and a number of the UFBs are generated.

Conversely, when the pressure of the liquid increases to be higher than normal temperature, the dissolution properties of the gas are increased, and the generated UFBs are more likely to be liquefied. However, such pressure is sufficiently higher than the atmospheric pressure. Additionally, since the once generated UFBs have a high internal pressure and large gas-liquid interface energy even when the pressure of the liquid increases, it is highly unlikely that there is exerted a sufficiently high pressure to break such a gas-liquid interface. In other words, the once generated UFBs do not disappear easily as long as the liquid is stored at normal temperature and normal pressure.

In this embodiment, the second UFBs 11B described with FIGS. 8A to 8C and the fourth UFBs 11D described with FIGS. 10A to 10C can be described as UFBs that are generated by utilizing such pressure dissolution properties of gas.

Those first to fourth UFBs generated by different causes are described individually above; however, the above-described generation causes occur simultaneously with the event of the film boiling. Thus, at least two types of the first to the fourth UFBs may be generated at the same time, and these generation causes may cooperate to generate the UFBs. It should be noted that it is common for all the generation causes to be induced by the volume change of the film boiling bubble generated by the film boiling phenomenon. In this specification, the method of generating the UFBs by utilizing the film boiling caused by the rapid heating as described above is referred to as a thermal-ultrafine bubble (T-UFB) generating method. Additionally, the UFBs generated by the T-UFB generating method are referred to as T-UFBs, and the liquid containing the T-UFBs generated by the T-UFB generating method is referred to as a T-UFB-containing liquid.

Almost all the air bubbles generated by the T-UFB generating method are 1.0 μm or less, and milli-bubbles and microbubbles are unlikely to be generated. That is, the T-UFB generating method allows dominant and efficient generation of the UFBs. Additionally, the T-UFBs generated by the T-UFB generating method have larger gas-liquid interface energy than that of the UFBs generated by a conventional method, and the T-UFBs do not disappear easily as long as being stored at normal temperature and normal pressure. Moreover, even if new T-UFBs are generated by new film boiling, it is possible to prevent disappearance of the already generated T-UFBs due to the impact from the new generation. That is, it can be said that the number and the concentration of the T-UFBs contained in the T-UFB-containing liquid have the hysteresis properties depending on the number of times the film boiling is made in the T-UFB-containing liquid. In other words, it is possible to adjust the concentration of the T-UFBs contained in the T-UFB-containing liquid by controlling the number of the heating elements provided in the T-UFB generating unit 300 and the number of the voltage pulse application to the heating elements.

Reference to FIG. 1 is made again. Once the T-UFB-containing liquid W with a desired UFB concentration is generated in the T-UFB generating unit 300, the UFB-containing liquid W is supplied to the post-processing unit 400.

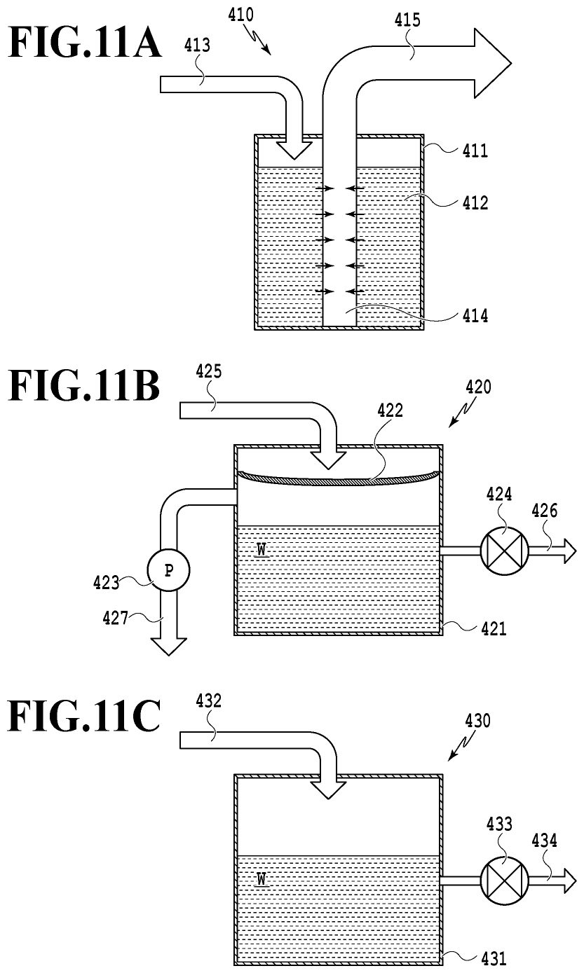

FIGS. 11A to 11C are diagrams illustrating configuration examples of the post-processing unit 400 of this embodiment. The post-processing unit 400 of this embodiment removes impurities in the UFB-containing liquid W in stages in the order from inorganic ions, organic substances, and insoluble solid substances.

FIG. 11A illustrates a first post-processing mechanism 410 that removes the inorganic ions. The first post-processing mechanism 410 includes an exchange container 411, cation exchange resins 412, a liquid introduction passage 413, a collecting pipe 414, and a liquid discharge passage 415. The exchange container 411 stores the cation exchange resins 412. The UFB-containing liquid W generated by the T-UFB generating unit 300 is injected to the exchange container 411 through the liquid introduction passage 413 and absorbed into the cation exchange resins 412 such that the cations as the impurities are removed. Such impurities include metal materials peeled off from the element substrate 12 of the T-UFB generating unit 300, such as SiO₂, SiN, SiC, Ta, Al₂O₃, Ta₂O₅, and Ir.

The cation exchange resins 412 are synthetic resins in which a functional group (ion exchange group) is introduced in a high polymer matrix having a three-dimensional network, and the appearance of the synthetic resins are spherical particles of around 0.4 to 0.7 mm. A general high polymer matrix is the styrene-divinylbenzene copolymer, and the functional group may be that of methacrylic acid series and acrylic acid series, for example. However, the above material is an example. As long as the material can remove desired inorganic ions effectively, the above material can be changed to various materials. The UFB-containing liquid W absorbed in the cation exchange resins 412 to remove the inorganic ions is collected by the collecting pipe 414 and transferred to the next step through the liquid discharge passage 415.

FIG. 11B illustrates a second post-processing mechanism 420 that removes the organic substances. The second post-processing mechanism 420 includes a storage container 421, a filtration filter 422, a vacuum pump 423, a valve 424, a liquid introduction passage 425, a liquid discharge passage 426, and an air suction passage 427. Inside of the storage container 421 is divided into upper and lower two regions by the filtration filter 422. The liquid introduction passage 425 is connected to the upper region of the upper and lower two regions, and the air suction passage 427 and the liquid discharge passage 426 are connected to the lower region thereof. Once the vacuum pump 423 is driven with the valve 424 closed, the air in the storage container 421 is discharged through the air suction passage 427 to make the pressure inside the storage container 421 negative pressure, and the UFB-containing liquid W is thereafter introduced from the liquid introduction passage 425. Then, the UFB-containing liquid W from which the impurities are removed by the filtration filter 422 is reserved into the storage container 421.

The impurities removed by the filtration filter 422 include organic materials that may be mixed at a tube or each unit, such as organic compounds including silicon, siloxane, and epoxy, for example. A filter film usable for the filtration filter 422 includes a filter of a sub-μm-mesh (a filter of 1 μm or smaller in mesh diameter) that can remove bacteria, and a filter of a nm-mesh that can remove virus.

After a certain amount of the UFB-containing liquid W is reserved in the storage container 421, the vacuum pump 423 is stopped and the valve 424 is opened to transfer the T-UFB-containing liquid in the storage container 421 to the next step through the liquid discharge passage 426. Although the vacuum filtration method is employed as the method of removing the organic impurities herein, a gravity filtration method and a pressurized filtration can also be employed as the filtration method using a filter, for example.

FIG. 11C illustrates a third post-processing mechanism 430 that removes the insoluble solid substances. The third post-processing mechanism 430 includes a precipitation container 431, a liquid introduction passage 432, a valve 433, and a liquid discharge passage 434.

First, a predetermined amount of the UFB-containing liquid W is reserved into the precipitation container 431 through the liquid introduction passage 432 with the valve 433 closed, and leaving it for a while. Meanwhile, the solid substances in the UFB-containing liquid W are precipitated onto the bottom of the precipitation container 431 by gravity. Among the bubbles in the UFB-containing liquid, relatively large bubbles such as microbubbles are raised to the liquid surface by the buoyancy and also removed from the UFB-containing liquid. After a lapse of sufficient time, the valve 433 is opened, and the UFB-containing liquid W from which the solid substances and large bubbles are removed is transferred to the collecting unit 500 through the liquid discharge passage 434. The example of applying the three post-processing mechanisms in sequence is shown in this embodiment; however, it is not limited thereto, and the order of the three post-processing mechanisms may be changed, or at least one needed post-processing mechanism may be employed.

Reference to FIG. 1 is made again. The T-UFB-containing liquid W from which the impurities are removed by the post-processing unit 400 may be directly transferred to the collecting unit 500 or may be put back to the dissolving unit 200 again. In the latter case, the gas dissolution concentration of the T-UFB-containing liquid W that is decreased due to the generation of the T-UFBs can be compensated to the saturated state again by the dissolving unit 200. If new T-UFBs are generated by the T-UFB generating unit 300 after the compensation, it is possible to further increase the concentration of the UFBs contained in the T-UFB-containing liquid with the above-described properties. That is, it is possible to increase the concentration of the contained UFBs by the number of circulations through the dissolving unit 200, the T-UFB generating unit 300, and the post-processing unit 400, and it is possible to transfer the UFB-containing liquid W to the collecting unit 500 after a predetermined concentration of the contained UFBs is obtained.

The collecting unit 500 collects and preserves the UFB-containing liquid W transferred from the post-processing unit 400. The T-UFB-containing liquid collected by the collecting unit 500 is a UFB-containing liquid with high purity from which various impurities are removed.

In the collecting unit 500, the UFB-containing liquid W may be classified by the size of the T-UFBs by performing some stages of filtration processing. Since it is expected that the temperature of the T-UFB-containing liquid W obtained by the T-UFB method is higher than normal temperature, the collecting unit 500 may be provided with a cooling unit. The cooling unit may be provided to a part of the post-processing unit 400.

The schematic description of the UFB generating apparatus 1 is given above; however, it is needless to say that the illustrated multiple units can be changed, and not all of them need to be prepared. Depending on the type of the liquid W and the gas G to be used and the intended use of the T-UFB-containing liquid to be generated, a part of the above-described units may be omitted, or another unit other than the above-described units may be added.

For example, when the gas to be contained by the UFBs is the atmospheric air, the degassing unit as the pre-processing unit 100 and the dissolving unit 200 can be omitted. On the other hand, when multiple kinds of gases are desired to be contained by the UFBs, another dissolving unit 200 may be added.

The units for removing the impurities as described in FIGS. 11A to 11C may be provided upstream of the T-UFB generating unit 300 or may be provided both upstream and downstream thereof. When the liquid to be supplied to the UFB generating apparatus is tap water, rain water, contaminated water, or the like, there may be included organic and inorganic impurities in the liquid. If such a liquid W including the impurities is supplied to the T-UFB generating unit 300, there is a risk of deteriorating the heating element 10 and inducing the salting-out phenomenon. With the mechanisms as illustrated in FIGS. 11A to 11C provided upstream of the T-UFB generating unit 300, it is possible to remove the above-described impurities previously.

### <<Liquid and Gas Usable for T-UFB-Containing Liquid>>

Now, the liquid W usable for generating the T-UFB-containing liquid is described. The liquid W usable in this embodiment is, for example, pure water, ion exchange water, distilled water, bioactive water, magnetic active water, lotion, tap water, sea water, river water, clean and sewage water, lake water, underground water, rain water, and so on. A mixed liquid containing the above liquid and the like is also usable. A mixed solvent containing water and soluble organic solvent can be also used. The soluble organic solvent to be used by being mixed with water is not particularly limited; however, the followings can be a specific example thereof. An alkyl alcohol group of the carbon number of 1 to 4 including methyl alcohol, ethyl alcohol, n-propyl alcohol, isopropyl alcohol, n-butyl alcohol, sec-butyl alcohol, and tert-butyl alcohol. An amide group including N-methyl-2-pyrrolidone, 2-pyrrolidone, 1,3-dimethyl-2-imidazolidinone, N,N-dimethylformamide, and N,N-dimethylacetamide. A keton group or a ketoalcohol group including acetone and diacetone alcohol. A cyclic ether group including tetrahydrofuran and dioxane. A glycol group including ethylene glycol, 1,2-propylene glycol, 1,3-propylene glycol, 1,2-butanediol, 1,3-butanediol, 1,4-butanediol, 1,5-pentanediol, 1,2-hexanediol, 1,6-hexanediol, 3-methyl-1,5-pentanediol, diethylene glycol, triethylene glycol, and thiodiglycol. A group of lower alkyl ether of polyhydric alcohol including ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, and triethylene glycol monobutyl ether. A polyalkylene glycol group including polyethylene glycol and polypropylene glycol. A triol group including glycerin, 1,2,6-hexanetriol, and trimethylolpropane. These soluble organic solvents can be used individually, or two or more of them can be used together.

A gas component that can be introduced into the dissolving unit 200 is, for example, hydrogen, helium, oxygen, nitrogen, methane, fluorine, neon, carbon dioxide, ozone, argon, chlorine, ethane, propane, air, and so on. The gas component may be a mixed gas containing some of the above. Additionally, it is not necessary for the dissolving unit 200 to dissolve a substance in a gas state, and the dissolving unit 200 may fuse a liquid or a solid containing desired components into the liquid W. The dissolution in this case may be spontaneous dissolution, dissolution caused by pressure application, or dissolution caused by hydration, ionization, and chemical reaction due to electrolytic dissociation.

### <<Effects of T-UFB Generating Method>>

Next, the characteristics and the effects of the above-described T-UFB generating method are described by comparing with a conventional UFB generating method. For example, in a conventional air bubble generating apparatus as represented by the Venturi method, a mechanical depressurizing structure such as a depressurizing nozzle is provided in a part of a flow passage. A liquid flows at a predetermined pressure to pass through the depressurizing structure, and air bubbles of various sizes are generated in a downstream region of the depressurizing structure.

In this case, among the generated air bubbles, since the relatively large bubbles such as milli-bubbles and microbubbles are affected by the buoyancy, such bubbles rise to the liquid surface and disappear. Even the UFBs that are not affected by the buoyancy may also disappear with the milli-bubbles and microbubbles since the gas-liquid interface energy of the UFBs is not very large. Additionally, even if the above-described depressurizing structures are arranged in series, and the same liquid flows through the depressurizing structures repeatedly, it is impossible to store for a long time the UFBs of the number corresponding to the number of repetitions. In other words, it has been difficult for the UFB-containing liquid generated by the conventional UFB generating method to maintain the concentration of the contained UFBs at a predetermined value for a long time.

In contrast, in the T-UFB generating method of this embodiment utilizing the film boiling, a rapid temperature change from normal temperature to about 300° C. and a rapid pressure change from normal pressure to around a several megapascal occur locally in a part extremely close to the heating element. The heating element is a rectangular shape having one side of around several tens to hundreds of μm. It is around 1/10 to 1/1000 of the size of a conventional UFB generating unit. Additionally, with the gas-dissolved liquid within the extremely thin film region of the film boiling bubble surface exceeding the thermal dissolution limit or the pressure dissolution limit instantaneously (in an extremely short time under microseconds), the phase transition occurs and the gas-dissolved liquid is precipitated as the UFBs. In this case, the relatively large bubbles such as milli-bubbles and microbubbles are hardly generated, and the liquid contains the UFBs of about 100 nm in diameter with extremely high purity. Moreover, since the T-UFBs generated in this way have sufficiently large gas-liquid interface energy, the T-UFBs are not broken easily under the normal environment and can be stored for a long time.

Particularly, the present invention using the film boiling phenomenon that enables local formation of a gas interface in the liquid can form an interface in a part of the liquid close to the heating element without affecting the entire liquid region, and a region on which the thermal and pressure actions performed can be extremely local. As a result, it is possible to stably generate desired UFBs. With further more conditions for generating the UFBs applied to the generation liquid through the liquid circulation, it is possible to additionally generate new UFBs with small effects on the already-made UFBs. As a result, it is possible to produce a UFB liquid of a desired size and concentration relatively easily.

Moreover, since the T-UFB generating method has the above-described hysteresis properties, it is possible to increase the concentration to a desired concentration while keeping the high purity. In other words, according to the T-UFB generating method, it is possible to efficiently generate a long-time storable UFB-containing liquid with high purity and high concentration.

### <<Specific Usage of T-UFB-Containing Liquid>>

In general, applications of the ultrafine bubble-containing liquids are distinguished by the type of the containing gas. Any type of gas can make the UFBs as long as an amount of around PPM to BPM of the gas can be dissolved in the liquid. For example, the ultrafine bubble-containing liquids can be applied to the following applications.
A UFB-containing liquid containing air can be preferably applied to cleansing in the industrial, agricultural and fishery, and medical scenes and the like, and to cultivation of plants and agricultural and fishery products.
A UFB-containing liquid containing ozone can be preferably applied to not only cleansing application in the industrial, agricultural and fishery, and medical scenes and the like, but to also applications intended to disinfection, sterilization, and decontamination, and environmental cleanup of drainage and contaminated soil, for example.
A UFB-containing liquid containing nitrogen can be preferably applied to not only cleansing application in the industrial, agricultural and fishery, and medical scenes and the like, but to also applications intended to disinfection, sterilization, and decontamination, and environmental cleanup of drainage and contaminated soil, for example.
A UFB-containing liquid containing oxygen can be preferably applied to cleansing application in the industrial, agricultural and fishery, and medical scenes and the like, and to cultivation of plants and agricultural and fishery products.
A UFB-containing liquid containing carbon dioxide can be preferably applied to not only cleansing application in the industrial, agricultural and fishery, and medical scenes and the like, but to also applications intended to disinfection, sterilization, and decontamination, for example.
A UFB-containing liquid containing perfluorocarbons as a medical gas can be preferably applied to ultrasonic diagnosis and treatment. As described above, the UFB-containing liquids can exert the effects in various fields of medical, chemical, dental, food, industrial, agricultural and fishery, and so on.

In each of the applications, the purity and the concentration of the UFBs contained in the UFB-containing liquid are important for quickly and reliably exert the effect of the UFB-containing liquid. In other words, unprecedented effects can be expected in various fields by utilizing the T-UFB generating method of this embodiment that enables generation of the UFB-containing liquid with high purity and desired concentration. Here is below a list of the applications in which the T-UFB generating method and the T-UFB-containing liquid are expected to be preferably applicable.

### (A) Liquid Purification Application

With the T-UFB generating unit provided to a water clarification unit, enhancement of an effect of water clarification and an effect of purification of PH adjustment liquid is expected. The T-UFB generating unit may also be provided to a carbonated water server.
With the T-UFB generating unit provided to a humidifier, aroma diffuser, coffee maker, and the like, enhancement of a humidifying effect, a deodorant effect, and a scent spreading effect in a room is expected.
If the UFB-containing liquid in which an ozone gas is dissolved by the dissolving unit is generated and is used for dental treatment, burn treatment, and wound treatment using an endoscope, enhancement of a medical cleansing effect and an antiseptic effect is expected.
With the T-UFB generating unit provided to a water storage tank of a condominium, enhancement of a water clarification effect and chlorine removing effect of drinking water to be stored for a long time is expected.
If the T-UFB-containing liquid containing ozone or carbon dioxide is used for brewing process of Japanese sake, shochu, wine, and so on in which the high-temperature pasteurization processing cannot be performed, more efficient pasteurization processing than that with the conventional liquid is expected.
If the UFB-containing liquid is mixed into the ingredient in a production process of the foods for specified health use and the foods with functional claims, the pasteurization processing is possible, and thus it is possible to provide safe and functional foods without a loss of flavor.
With the T-UFB generating unit provided to a supplying route of sea water and fresh water for cultivation in a cultivation place of fishery products such as fish and pearl, prompting of spawning and growing of the fishery products is expected.
With the T-UFB generating unit provided in a purification process of water for food preservation, enhancement of the preservation state of the food is expected.
With the T-UFB generating unit provided in a bleaching unit for bleaching pool water or underground water, a higher bleaching effect is expected.
With the T-UFB-containing liquid used for repairing a crack of a concrete member, enhancement of the effect of crack repairment is expected.
With the T-UFBs contained in liquid fuel for a machine using liquid fuel (such as automobile, vessel, and airplane), enhancement of energy efficiency of the fuel is expected.

### (B) Cleansing Application

Recently, the UFB-containing liquids have been receiving attention as cleansing water for removing soils and the like attached to clothing. If the T-UFB generating unit described in the above embodiment is provided to a washing machine, and the UFB-containing liquid with higher purity and better permeability than the conventional liquid is supplied to the washing tub, further enhancement of detergency is expected.
With the T-UFB generating unit provided to a bath shower and a bedpan washer, not only a cleansing effect on all kinds of animals including human body but also an effect of prompting contamination removal of a water stain and a mold on a bathroom and a bedpan are expected.
With the T-UFB generating unit provided to a window washer for automobiles, a high-pressure washer for cleansing wall members and the like, a car washer, a dishwasher, a food washer, and the like, further enhancement of the cleansing effects thereof is expected.
With the T-UFB-containing liquid used for cleansing and maintenance of parts produced in a factory including a burring step after pressing, enhancement of the cleansing effect is expected.
In production of semiconductor elements, if the T-UFB-containing liquid is used as polishing water for a wafer, enhancement of the polishing effect is expected. Additionally, if the T-UFB-containing liquid is used in a resist removal step, prompting of peeling of resist that is not peeled off easily is enhanced.
With the T-UFB generating unit is provided to machines for cleansing and decontaminating medical machines such as a medical robot, a dental treatment unit, an organ preservation container, and the like, enhancement of the cleansing effect and the decontamination effect of the machines is expected. The T-UFB generating unit is also applicable to treatment of animals.

### (C) Pharmaceutical Application

If the T-UFB-containing liquid is contained in cosmetics and the like, permeation into subcutaneous cells is prompted, and additives that give bad effects to skin such as preservative and surfactant can be reduced greatly. As a result, it is possible to provide safer and more functional cosmetics.
If a high concentration nanobubble preparation containing the T-UFBs is used for contrasts for medical examination apparatuses such as a CT and an MRI, reflected light of X-rays and ultrasonic waves can be efficiently used. This makes it possible to capture a more detailed image that is usable for initial diagnosis of a cancer and the like.
If a high concentration nanobubble water containing the T-UFBs is used for a ultrasonic wave treatment machine called high-intensity focused ultrasound (HIFU), the irradiation power of ultrasonic waves can be reduced, and thus the treatment can be made more non-invasive. Particularly, it is possible to reduce the damage to normal tissues.
It is possible to create a nanobubble preparation by using high concentration nanobubbles containing the T-UFBs as a source, modifying a phospholipid forming a liposome in a negative electric charge region around the air bubble, and applying various medical substances (such as DNA and RNA) through the phospholipid.
If a drug containing high concentration nanobubble water made by the T-UFB generation is transferred into a dental canal for regenerative treatment of pulp and dentine, the drug enters deeply a dentinal tubule by the permeation effect of the nanobubble water, and the decontamination effect is prompted. This makes it possible to treat the infected root canal of the pulp safely in a short time.

### First Embodiment

Next, a first embodiment of the present invention is described. In this embodiment, an example in which a UFB-containing liquid having a target UFB concentration is generated, while target generation time is predicted with high accuracy based on the specification and the control setting of the heating elements to notify a user of the predicted target generation time is described.

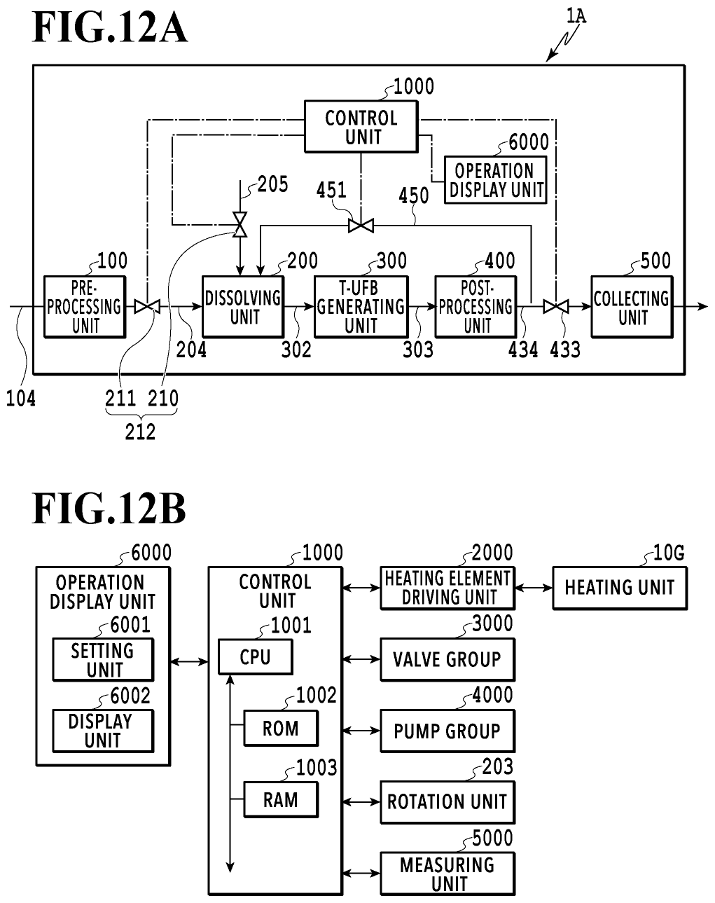

FIG. 12A is a diagram illustrating a schematic configuration of a UFB generating apparatus 1A in this embodiment. As with the one described in the above-described basic configuration, the UFB generating apparatus 1A described herein includes the pre-processing unit 100, the dissolving unit 200, the T-UFB generating unit 300, the post-processing unit 400, and the collecting unit 500. However, the UFB generating apparatus 1A in this embodiment is provided with a reflux route 450 that introduces the UFB-containing liquid generated in the post-processing unit 400 to the dissolving unit 200. To be specific, one end of the reflux route 450 is connected upstream of the discharge valve 433 in the liquid discharge passage 434 (see FIG. 11C) of the post-processing unit 400, and the other end of the reflux route 450 is connected to the dissolving container 201 (see FIG. 3A) of the dissolving unit 200. Additionally, the reflux route 450 is provided with a circulation valve 451 that switches between communication and shut-off of the route 450.

Additionally, in FIG. 12A, 210 indicates a gas introduction valve that is provided in the gas introduction passage 205 of the dissolving unit 200, and 211 indicates a liquid introduction valve 211 that is provided in the liquid introduction passage 204 of the dissolving unit 200. In the following descriptions, these valves 210 and 211 are also collectively called an introduction valve 212. The introduction valve 212, the discharge valve 433, and the circulation valve 421 are controlled by a control unit 1000 described below.

In this embodiment, it is possible to form a circulation route as a liquid route by closing the introduction valve 212 and the discharge valve 433 and opening the circulation valve 421. That is, it is possible to form a circulation route that puts back the liquid in the dissolving unit 200 to the dissolving unit 200 again by way of the T-UFB generating unit 300, the post-processing unit 400, and the reflux route 420.

FIG. 12B is a diagram illustrating a schematic configuration of a control system of the UFB generating apparatus 1A in this embodiment. In FIG. 12B, a control unit 1000 includes a CPU 1001, a ROM 1002, a RAM 1003, and so on, for example. The CPU 1001 serves as a control unit that controls overall the entirety of the UFB generating apparatus 1A. The ROM 1002 stores a control program executed by the CPU 1001, a predetermined table, and other fixed data. The RAM 1003 includes an area for temporarily storing various input data, a workspace for executing processing by the CPU 1001, and the like. An operation display unit 6000 includes a setting unit 6001 that functions as a setting unit for performing operations for various setting including the UFB generation concentration, the UFB generation time, and the like by the user, and a display unit 6002 as a display unit that displays required time for generation of the UFB-containing liquid and a status of the device, for example.

The control unit 1000 controls a heating element driving unit (driving unit) 2000 that drives each heating element 10 of a heating unit 10G, which includes the multiple heating elements 10 provided on the element substrate 12. The heating element driving unit 2000 applies a driving pulse according to a control signal from the CPU 1001 to each of the multiple heating elements 10 included in the heating unit 10G. Each heating element 10 radiates heat according to a voltage, a frequency, a pulse width, and the like of the applied driving pulse.

The control unit 1000 controls a valve group 3000 including the valves provided in the units. The valve group 3000 also includes the above-described introduction valve 212, discharge valve 433, circulation valve 451, and the like. Additionally, the control unit 1000 also controls a pump group 4000 including various pumps provided in the UFB generating apparatus, a rotation shaft 203 provided in the dissolving unit 200, and the like. Additionally, as described in the basic configuration, the T-UFB generating unit 300 is provided with a measuring unit that performs measurement for estimating the UFB concentration of the UFB-containing liquid being generated, and the measurement value that is measured by the measuring unit is inputted to the control unit 1000. Other configurations are similar to that of the above-described UFB generating apparatus 1, and duplicated descriptions are omitted.

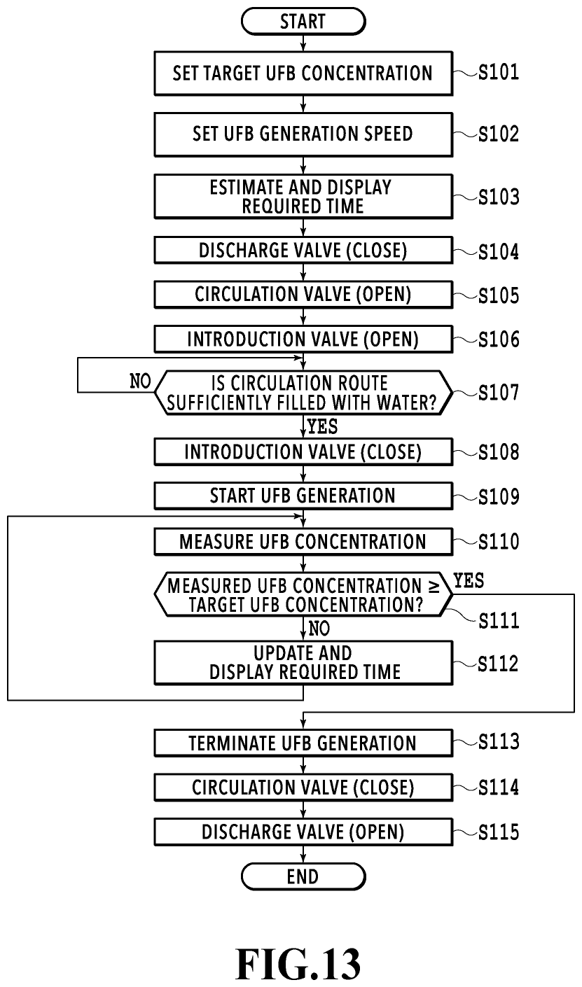

Next, generation operations for the UFBs executed in the first embodiment are described according to the flowchart in FIG. 13. A series of processing indicated in the flowcharts of FIGS. 13, 16, 18, and 20 used in the following descriptions is performed with the CPU 1001 deploying and executing a program code stored in the ROM 1002 into the RAM 1003. Otherwise, a part of or all the functions in FIGS. 13, 16, 18, and 20 may be implemented by hardware such as an ASIC, an electronic circuit, and the like. The sign “S” in the description of each processing means a step in the description of each processing.

First, in S101, a target UFB concentration of the UFB-containing liquid is set. In this embodiment, it is assumed that the number of the UFBs per 1 mL is set, and the setting value is 100 million pieces/mL. Additionally, it is assumed that an amount of the UFB-containing liquid to be generated is 1 L (liter).

Next, in S102, a UFB generation speed, that is, a driving frequency, which is the number of times of driving per second of the driving of the heating elements 10, is set. In this embodiment, it is assumed that the total number of the heating elements 10 used for the UFB generation is fixed to 10 thousand pieces. Therefore, according to the target UFB concentration, the driving frequency of the heating elements 10 is set to 10 kHz. This target UFB concentration can be set by the user through the setting unit 6001.

Next, in S103, required time for generating a UFB-containing liquid having the UFB concentration set as described above is obtained, and the required time (estimated generation time) is displayed on the display unit 6002.

This estimated generation time is calculated based on generation conditions i) and ii) below:

i) total number of heating element=1.0e4 (=1.0×10⁴); and

ii) UFB generation speed=(1.0e4)×10×(1.0e4)=1.0e9 (pieces/second).

Accordingly, the generation time (the number of seconds) for generating one L of the UFB-containing liquid having the UFB concentration of 100 million pieces/mL is:

$$( 1.0 e 8 ( pieces \text{/} mL ) \times 1.0 e 3 ( mL ) ) \div 1.0 e 9 ( pieces \text{/} second ) ) = 1.0 e 2 ( seconds ) = 100 ( seconds ) .$$

Therefore, “estimated generation time=100 seconds” or “00 hour 01 minute 40 seconds” is displayed on the display unit 6002, for example. In this process, if the estimated generation time is unsatisfying, it is possible to return to S101 or S102 again so as to set a desired target concentration and UFB generation speed again with the setting unit 6001 by the user. In this way, it is possible to generate the UFB-containing liquid having the UFB concentration the user needs in desired production time and to improve the production accuracy.

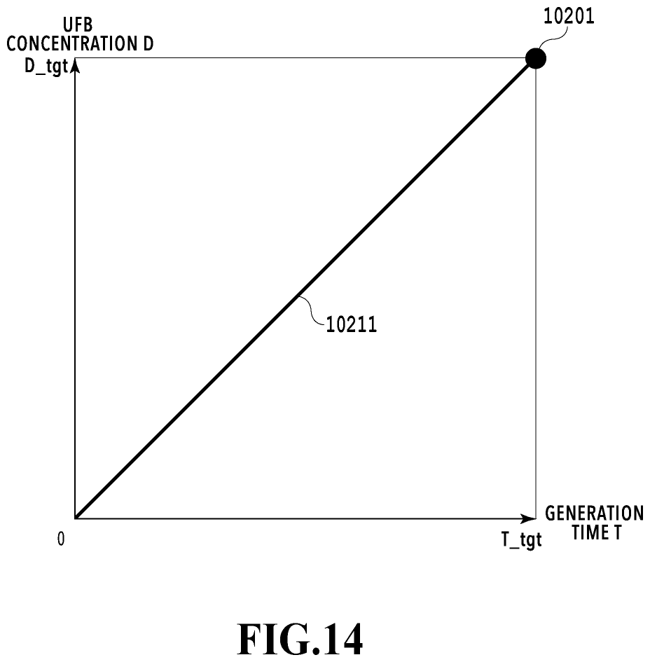

FIG. 14 is a diagram illustrating a relationship between estimated generation time T for the UFBs that is calculated in S103 and the UFB concentration of the UFB-containing liquid. A point 10201 in the diagram indicates that the UFB concentration of the UFB-containing liquid to be generated is expected to reach a target UFB concentration D_tgt (=UFBs of 1.0e8 pieces/mL) in estimated generation time T_tgt (=100 seconds). A straight line 10211 illustrated in FIG. 14 indicates an estimation value of the increasing UFB concentration with the elapse of the generation time.

Subsequently, preparing operations for the UFB generation are performed. First, in S104, the discharge valve 433 is closed. Next, in S105, the circulation valve 451 is opened, and in S106, the introduction valve 212 (the liquid introduction valve 211 and the gas introduction valve 210) is opened. With the liquid introduction valve 211 being opened, the liquid (in this case, water) that is pre-processed by the pre-processing unit 100 is introduced into the dissolving unit 200, and inside the dissolving unit 200 is filled with the water. Additionally, with the gas introduction valve 210 being opened, the dissolving unit 200 becomes capable of introducing the air.

In the dissolving unit 200, after the air is dissolved into the water, the water in which the air is dissolved is transferred to the T-UFB generating unit 300. The liquid transferred to the T-UFB generating unit 300 is transferred to the post-processing unit 400 and then transferred to the reflux route 450.

Thereafter, in S107, whether the reflux route 450 is sufficiently filled with the water is determined based on a detection result from a liquid detection sensor outside the diagram, and if the determination result is No, the determination processing in S107 is repeated while continuing the supplying of the water to the circulation flow passage 420. Then, if the determination result in S107 becomes Yes, the process proceeds to S108, and the introduction valve 212 (the liquid introduction valve 211 and the gas introduction valve 210) is closed. With the above procedure, the preparing operations for the UFB generation are completed.

Subsequently, the UFB generation processing is performed. First, in S108, the UFB generation processing by the heating elements 10 is started. In this case, the UFB generation processing is performed by applying the driving pulse of the driving frequency set in S102 to each of the 10 thousand pieces of the heating elements 10. In this way, the UFBs are generated in the water supplied in the T-UFB generating unit 300. In this process, a circulation is made in the reflux route 450, which is from the dissolving unit 200 to the dissolving unit 200 by way of the T-UFB generating unit 300 and the post-processing unit 400, in the device. Therefore, during the circulation in the reflux route 450, the UFBs generated in the T-UFB generating unit 300 is mixed into the water, and the UFB concentration in the UFB-containing liquid is increased.

When certain time has elapsed from starting the UFB generation in S109, the current UFB concentration of the UFB-containing liquid that is circulating in the reflux route 450 is measured by a measuring unit 5000 in S110. As for the measuring unit, there have been known a measurement method in which the number of the UFBs in the UFB-containing liquid is optically counted by using a magnifying glass and a camera to measure the UFB concentration, a method of measuring the UFB concentration by measuring a Z potential, and the like; however, anything adopting any concentration detection method may be applicable.

In S111, whether the UFB concentration measured in S110 is equal to or more than the target UFB concentration set in S101 is determined. If the determination result is Yes, the process proceeds to S113, and the UFB generation processing is terminated. If the determination result is No, the process proceeds to S112 to further increase the UFB concentration.

In S112, required time for the UFB concentration of the UFB-containing liquid to reach the target concentration is recalculated to update the required time, and the updated required time is displayed. In this process, as with the processing of estimating and displaying the required time performed in S103, remaining required time for generating the UFB-containing liquid having the target UFB concentration is calculated, and the remaining required time is displayed on the display unit 6002. The reason why such update of the required time is needed is because the generation performance of the UFB generating apparatus 1A is slightly varied due to temperature such as water temperature, heating element temperature, device temperature, and environment temperature outside the device, and other factors.

Now, a specific example of the update processing for the required time (estimated generation time) is described. As an example, description is given while assuming a case in which the UFB concentration (the number of the UFBs per 1 mL) measured at a time point at which a period of time of about 50 seconds has elapsed from starting the UFB generation is 4.0e7 pieces/mL and does not reach 1.0e8 pieces/mL, which is the target.

In this case, in order to allow the concentration of the UFB-containing liquid to reach the target concentration, it is required to further generate one L of the UFBs of 6.0e7 pieces/mL in the current UFB-containing liquid. The required generation time (the number of seconds) for this purpose is:

(0.6e8 (pieces/mL)×1.0e3 (mL))÷1.0e9 (pieces/second))=0.6e2 (seconds).

Therefore, the displayed content that is displayed as “estimated generation time=50 seconds”, “00 hour 00 minute 50 seconds”, or the like if it is determined as Yes in the determination processing in S111 is updated to “estimated generation time=60 seconds”, “00 hour 01 minute 00 seconds”, or the like.

Additionally, if the heating element temperature indicates a temperature higher than a predetermined value, the generation of the T-UFBs is stopped, and the processing is terminated. This is because, unlike the conventional UFB generating method, if the heating of the heating elements is continued while the moisture on the heating elements is lost due to a breakage of a device container, a failure of a water amount detection sensor, or the like, for example, the temperature of the heating elements and surroundings becomes excessively high.

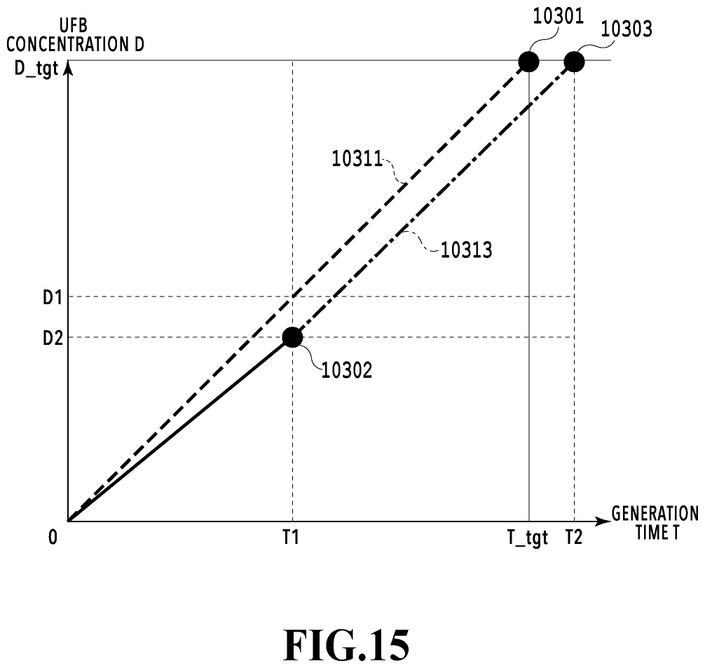

FIG. 15 is a diagram illustrating a relationship between the estimated generation time T for the UFBs calculated in S112 and the UFB concentration of the UFB-containing liquid. A point 10301 illustrated in FIG. 15 indicates that the UFB concentration of the UFB-containing liquid to be generated is expected to reach the target UFB concentration D_tgt (=UFBs of 1.0e8 pieces/mL) in the estimated generation time T_tgt (=100 seconds). Additionally, a broken line 10311 illustrated in FIG. 15 indicates an initial estimated concentration of the UFB-containing liquid that is increased with the elapse of the generation time.

On the other hand, a point 10302 illustrated in FIG. 15 indicates a UFB concentration D2 (=4.0e7 pieces/mL) at a time point at which generation time T1 (=50 seconds) has elapsed. Additionally, a UFB concentration D1 (=UFBs of 5.0e7 pieces/mL) indicates an initial estimated UFB concentration at the time point at which the generation time T1 (=50 seconds) has elapsed.

Moreover, a point 10303 illustrated in FIG. 15 indicates estimated generation time T2 (=50 seconds+60 seconds) that is updated by the update processing for the required time in S112 described above. Furthermore, a dashed-dotted line 10313 in FIG. 15 indicates an updated estimation value of the increasing UFB concentration with the elapse of the generation time.

In S112, if the required time is updated and displayed, the process returns to S110 again to measure the UFB concentration while continuing the UFB generation processing, and the determination processing in S111 is performed based on the measurement result of the measured UFB concentration. Then, if the determination result in S111 is Yes, the process proceeds to S113, and the UFB generation processing is terminated. Thereafter, in S114, the circulation valve 451 is closed, and in S115, the discharge valve 433 is opened. In this way, the UFB-containing liquid generated from the T-UFB generating unit 300 by way of the post-processing unit 400 is discharged into the collecting unit 500. With the above procedure, a series of the generation processing for the UFB-containing liquid is terminated.

As described above, according to this embodiment using the T-UFB method, it is possible to control the generation speed and the UFB concentration of the UFB-containing liquid with high accuracy by controlling how many heating elements 10 generating the UFBs are used and how many times each heating element 10 is driven per second. Additionally, depending on the difference between a UFB concentration as the target in the generation operation for the UFB-containing liquid and an actual UFB concentration, the required time for generating a predetermined amount of the UFB-containing liquid having the desired UFB concentration is estimated with high accuracy, and the user is notified of the result. Consequently, the user is able to figure out the accurate required time for the generation time of the UFB-containing liquid.

In the above-described embodiment, the example in which the required time for the UFB-containing liquid is recalculated and displayed every 50 seconds in S112 is described; however, in practice, it is possible to recalculate and display the required time at shorter time intervals. With the required time being recalculated and displayed at shorter time intervals, it is possible to estimate the time taken to reach the target UFB concentration with higher accuracy.

### Second Embodiment

In the first embodiment, the example in which the total number of the heating elements 10 used is fixed to a certain number (in the first embodiment, 10 thousand pieces) to generate the UFB-containing liquid is described. However, in practice, in the heating elements 10, the heating elements may lose the heating function due to a damage from heating, bubbling, and bubble disappearance. In this case, there arises a problem of reduction in the UFB amount to be generated.

To deal with this, in this embodiment, in a case where the UFB amount to be generated is lower than the initially assumed generation amount, the control to maintain a certain production amount by feedbacking the production result to the following processing is made.

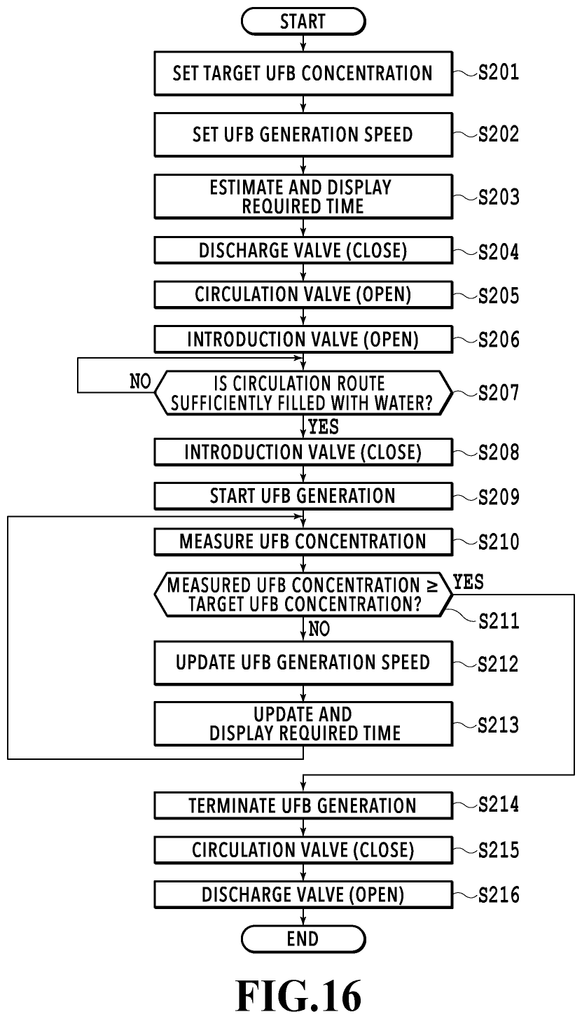

Hereinafter, the generation processing for the UFB-containing liquid that is executed in this embodiment is described according to the flowchart in FIG. 16. In FIG. 16, the processing in S201 to S211 is similar to the processing in S101 to S111 in FIG. 13; for this reason, duplicated descriptions are omitted.

In S211, if it is determined that the measured UFB concentration is less than the target UFB concentration (If the determination result is No), the process proceeds to S212, and the UFB generation speed is updated. This update processing for the UFB generation speed is performed as below.

In the following descriptions, a case in which the estimation processing for the required time in S203 is performed while assuming that 10 thousand pieces of the heating elements 10 are used but about two thousand pieces of the heating elements out of the assumed heating elements 10 lose the heating function in practice is described as an example. In this case, the measured UFB concentration at a time point at which the UFB generation speed has elapsed for about 50 seconds from starting the UFB generation is not 50 million pieces/mL but is 40 million pieces/mL as described below.

### (Actual UFB Generation Concentration)

Now, if two thousand pieces of the heating elements out of the 10 thousand pieces of the heating elements 10 lose the heating function, the total number of the usable heating elements is:

total number of usable heating elements=0.8e4 (=0.8×10⁴).

Additionally, the UFB generation speed is:

$$UFB generation speed = ( 0.8 e 4 ) \times 10 \times ( 1.0 e 4 ) = 0.8 e 9 ( pieces \text{/} second ) .$$

Therefore, the UFB concentration at the time point at which 50 seconds has elapsed from starting the UFB generation is:

(0.8e9 (pieces/second)×50 (seconds)÷1.0e3 (mL))=0.4e8.

Accordingly, in S210, the UFB concentration of 40 million pieces/mL is obtained as the measurement result. Since this UFB concentration obtained as the measurement result is lower than the target UFB concentration, which is 50 million pieces/mL, it is determined as No in the determination processing in the following S211.

Therefore, the process proceeds to S212, and the update processing for the UFB generation speed described below is performed. This update processing is performed as below.

### (Calculation of Actual UFB Generation Speed)

In S212, the actual UFB generation speed implemented until then is calculated as below based on the UFB concentration measured in S210 and the elapsed time (50 (seconds)) from starting the UFB generation.

That is, the actual UFB generation speed is:

(4.0e7 (pieces/mL)×1.0e3 (mL))÷50 (seconds)=0.8e9 (pieces/second).

According to this calculation result, it is found out that the actually implemented UFB generation speed is 0.8e9 (pieces/second), which is 20 percent less than the initially assumed UFB generation speed, which is 1.0e9 (pieces/second).

In this embodiment, the control is made while assuming that the factor of the phenomenon of reduction in the UFB generation speed is because some of the heating elements 10 in the heating unit 10G lose the heating function. Therefore, in this embodiment, assuming that two thousand pieces of the heating elements lose the heating function, the total number of the heating elements used is updated to:

total number of heating elements=0.8e4 (=0.8×10⁴).

Then, the UFB generation speed is updated to:

UFB generation speed=(0.8e4)×10×(1.0e4)=0.8e9 (pieces/second).

Additionally, the UFB concentration of the UFB-containing liquid generated at the time point at which 50 (seconds) has elapsed from starting the UFB generation is updated to:

(0.8e9 (pieces/second)×50 (seconds)÷1.0e3 (mL))=0.4e8.

The above processing is performed in S212.

Next, in S213, the required time is recalculated and displayed. For the recalculation of the required time in this case, the total number of the heating elements and the UFB generation speed that are updated in S212 are used.

Therefore, the time (the number of seconds) required for generating one L of the UFB-containing liquid having the UFB concentration of the remaining 60 million pieces/mL is:

(0.6e8 (pieces/mL)×1.0e3 (mL))÷0.8e9 (pieces/second))=0.75e2 (seconds).

Therefore, on the display unit 6002, the initially displayed content, which is “estimated generation time=50 seconds”, “00 hour 00 minute 50 seconds”, or the like is updated to a displayed content such as “estimated generation time=75 seconds”, “00 hour 01 minute 15 seconds”, or the like.

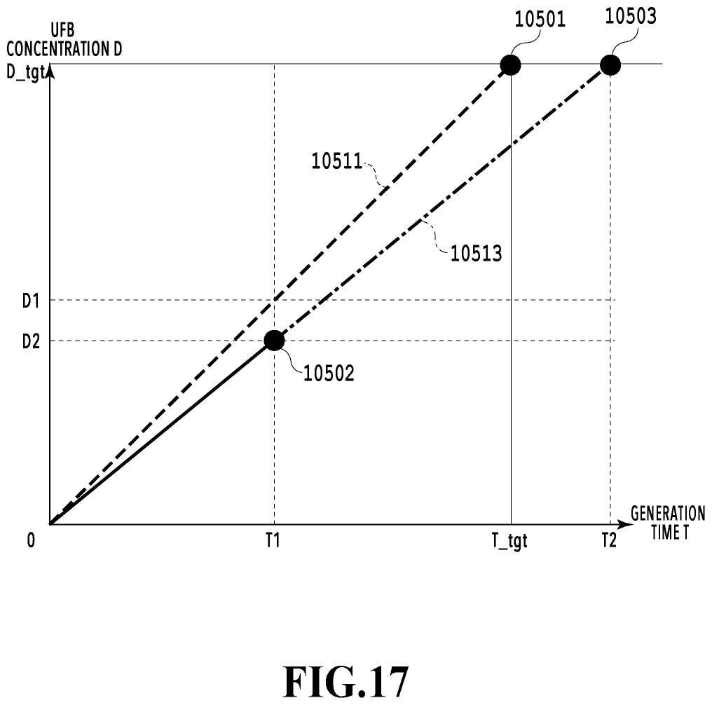

FIG. 17 is a diagram illustrating a relationship between the estimated generation time T for the UFBs calculated in S213 and the UFB concentration of the UFB-containing liquid. A point 10501 illustrated in FIG. 17 indicates that the UFB concentration of the UFB-containing liquid to be generated is expected to reach the initial target UFB concentration D_tgt (=1.0e8 pieces/mL) in the estimated generation time T_tgt (=100 seconds). Additionally, a broken line 10511 illustrated in FIG. 17 indicates an initial estimated concentration of the UFB-containing liquid that is increased along with the elapse of the generation time.

On the other hand, a point 10502 illustrated in FIG. 17 indicates the UFB concentration D2 (=6.0e7 pieces/mL) at the time point at which the generation time T1 (=50 seconds) has elapsed. Additionally, the UFB concentration D1 (=5.0e7 pieces/mL) indicates the initial estimated UFB concentration at the time point at which the elapsed time T1 (=50 seconds) has elapsed.

Moreover, a point 10503 illustrated in FIG. 17 indicates the estimated generation time T1 (=50 seconds+75 seconds) that is updated by the update processing for the required time in S213 described above. Furthermore, a dashed-dotted line 10513 in FIG. 17 indicates an updated estimation value of the increasing UFB concentration with the elapse of the generation time.

In S213, if the required time is updated and displayed, the process returns to S210 again to measure the UFB concentration while continuing the UFB generation processing, and the determination processing in S211 is performed based on the measurement result of the measured UFB concentration. Then, if the determination result in S211 is Yes, the process proceeds to S214, and the UFB generation processing is terminated. Thereafter, in S215, the circulation valve 451 is closed, and in S216, the discharge valve 433 is opened. In this way, the UFB-containing liquid processed in the T-UFB generating unit 300 and the post-processing unit 400 is discharged into the collecting unit 500. With the above procedure, a series of the generation processing for the UFB-containing liquid is terminated.

As described above, according to this embodiment, in order to control the number and the driving frequency of the heating elements 10 used, it is possible to control the generation speed and the UFB concentration of the UFB-containing liquid with high accuracy. Additionally, in this embodiment, it is possible to set the actual UFB generation speed with higher accuracy by updating the number of the heating elements that can be actually driven by using the UFB measurement result. Consequently, it is possible to estimate with higher accuracy and notify of the required time for generating a desired amount of the UFB-containing liquid having the desired UFB concentration.

Moreover, in this embodiment, in the generation operation for the UFB-containing liquid, it is possible to estimate the UFB generation required time with high accuracy by using the UFB generation speed set in a previous generation operation for the UFB-containing liquid. That is, it is possible to use the number of the heating elements used that is updated in S212 of the previous generation operation for the UFB-containing liquid (in the above-described example, the total number of 8000 pieces of the heating elements) in the setting processing for the UFB generation speed in S202 for the current generation operation. Therefore, in the current generation operation, it is possible to estimate and display with high accuracy the required time responding to a change in the performance of the UFB generating apparatus 1A in the first estimation processing for the required time (processing in S203).

Now, an example of calculating how is the time required for achieving the target number of the UFBs changed depending on the number of the drivable heating elements in this example is indicated in Table 1.

TABLE 1

| Target UFB | 100,000,000 pieces/ml | | | | |
|---|---|---|---|---|---|
| Concentration | | | | | |
| Target Amount of | 1,000 ml | | | | |
| UFB Water | | | | | |
| Generated | | | | | |
| Required Number | 100,000,000,000 pieces | | | | |
| of UFBs | | | | | |
| Number of UFBs | 10 pieces/heating | | | | |
| Generated Per | | | | | |
| Heating | | | | | |
| Number of Times of | 10,000 times/second | | | | |
| Driving Heating | | | | | |
| Element Per Second | | | | | |
| Number of Active | 10,000 pieces | 1,000 pieces | 100 pieces | 10 pieces | one piece |
| Heat Generation | | | | | |
| Elements | | | | | |
| Number of Usbs | 1,000,000,000 | 100,000,000 | 10,000,000 | 1,000,000 | 100,000 |
| Generated Per | pieces | pieces | pieces | pieces | pieces |
| Second | | | | | |
| Estimated Number | 100 | 1,000 | 10,000 | 100,000 | 1,000,000 |
| of Seconds to Reach | seconds | seconds | seconds | seconds | seconds |
| Target Number of | | | | | |
| UFBs | | | | | |
| Estimated Time | 0 | 0 | 2 | 27 | 277 |
| [hour] | | | | | |
| Estimated Time | 1 | 16 | 46 | 46 | 46 |
| [minute] | | | | | |
| Estimated Time | 40 | 40 | 40 | 40 | 40 |
| [second] | | | | | |

As can be seen from Table 1, in the T-UFB method, it is possible to estimate the time required for the UFB generation based on a result of figuring out the device performance.

The estimation on the required time in this embodiment is favorable for the estimation in a case in which a similar tendency that the heating elements lose the heating function is likely to be reproduced in the same operations thereafter.

Additionally, in this embodiment, the example in which the required time for the UFB-containing liquid is recalculated and displayed every 50 seconds in S213 is described; however, it is also possible in this embodiment to recalculate and display the required time at shorter time intervals. With this, it is possible to estimate the time taken to reach the target UFB concentration with higher accuracy.

Moreover, in this embodiment, the UFB generation speed and the number of the drivable heating elements are estimated based on the elapsed time T from starting the UFB generation and the generated UFB concentration D at the time point. However, the above-described estimation may be performed based on a variation in the device performance in shorter time. For example, it is possible to use a method in which the UFB concentration is measured every 10 seconds, and, for the estimation on the time point at which 50 seconds has elapsed, the difference between the UFB concentration D at the time point at which 50 seconds has elapsed and the UFB concentration D at a time point at which 40 seconds has elapsed is divided by the time difference of 10 seconds to estimate the UFB generation speed. This method is favorable for the estimation in a case in which the time required for a variation in the generation performance of the UFB generating apparatus is shorter than the UFB generation time.

### Third Embodiment

In the first and second embodiments, the example in which the required time for obtaining the UFB-containing liquid having the target UFB concentration by the T-UFB method can be estimated with high accuracy is described. In contrast, in a third embodiment, the control for making the actual UFB generation time close to the target generation time by controlling the UFB generation speed is made.

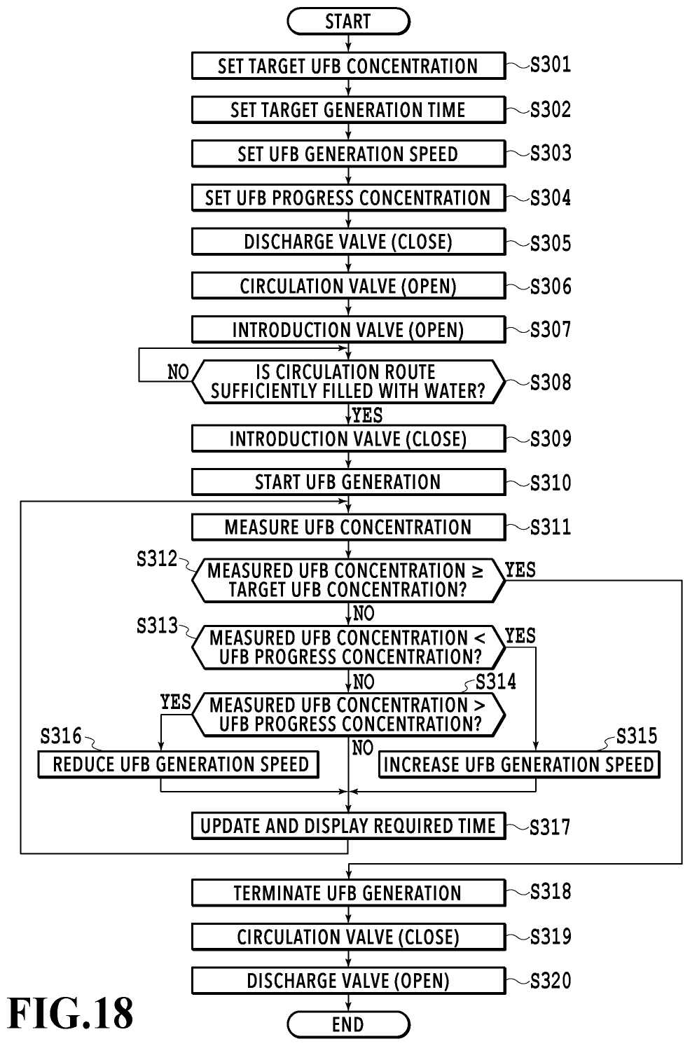

FIG. 18 is a flowchart illustrating the generation processing for the UFB-containing liquid that is executed in this embodiment.

In FIG. 18, processing in S301 to S303 is similar to the processing in S101 to S103 in FIG. 13; for this reason, duplicated descriptions are omitted.

In S304, based on the UFB generation speed set in S303 in the previous generation processing for the UFB-containing liquid, a UFB progress concentration according to the elapsed time is set.

In this example, it is assumed a case in which the UFB generation speed is 1.0e8 pieces/mL, and an estimation value of the progress UFB concentration at each elapsed time is as indicated in Table 2.

TABLE 2

| Elapsed Time | | Progress UFB Concentration |
|---|---|---|
| 0 | second | 0.00e8 pieces/mL |
| 20 | seconds | 0.20e8 pieces/mL |
| 40 | seconds | 0.40e8 pieces/mL |
| 60 | seconds | 0.60e8 pieces/mL |
| 80 | seconds | 0.80e8 pieces/mL |
| 100 | seconds | 1.00e8 pieces/mL |

In FIG. 18, S305 to S312 are similar to S104 to S111 in FIG. 13; for this reason, descriptions are omitted.

If the determination result in the determination processing in S312 is No, the process proceeds to S313. In S313, the UFB concentration measured in S311 is compared to the UFB progress concentration set in S304 to determine whether the measured UFB concentration does not reach the UFB progress concentration. If the determination result is Yes, the process proceeds to S315. In S315, the UFB generation speed is increased, and the process proceeds to S316.

If the determination result in S313 is No, the process proceeds to S314. In S314, whether the UFB concentration measured in S311 exceeds the UFB progress concentration set in S304 is determined. If the determination result is Yes, the process proceeds to S316. In S316, the UFB generation speed is reduced, and the process proceeds to S317.

If the determination result in the determination processing in S314 is No, it means that the measured UFB concentration is the same as the estimated UFB concentration; therefore, the process proceeds to S317 without updating the UFB generation speed. In S317, with the update of the UFB generation speed (increase in speed or reduction in speed) performed in S315 or S316, the latest required time is updated and displayed, and the process proceeds to S311 to continue the processing.

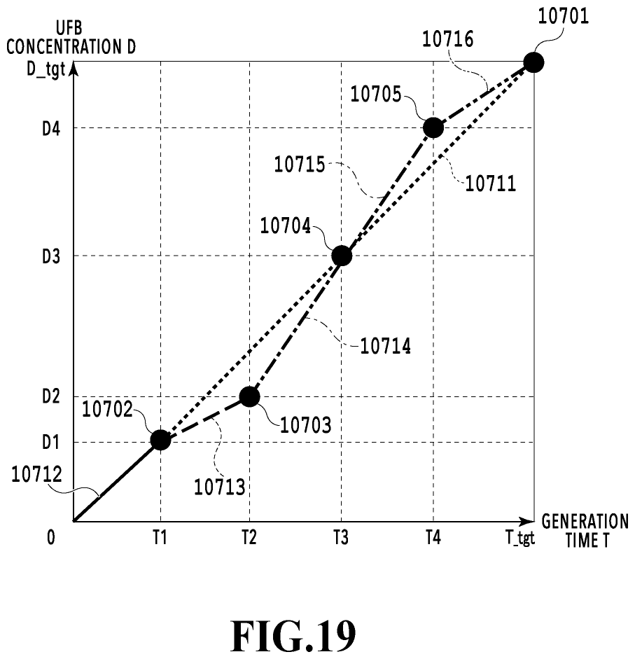

FIG. 19 is a diagram illustrating a relationship between the UFB generation time T and the generated UFB concentration D in a case where the UFB generation speed is controlled based on the measured UFB concentration in this embodiment.

A point 10701 illustrated in FIG. 19 indicates that the UFB concentration of the UFB-containing liquid to be generated is expected to reach the initial target UFB concentration D_tgt (=1.0e8 pieces/mL) in the estimated generation time T_tgt (=100 S). Additionally, a dotted line 10711 illustrated in FIG. 19 indicates the initial estimation value of the increasing UFB concentration with the elapse of the generation time.

Here is described an example in which the UFB generation is performed as initially expected in 20 seconds (T1) from starting the UFB generation, but after the elapse of 20 seconds, some of the heating elements 10 lose the heating function, and the UFB generation speed is reduced, and no loss of the function of the heating elements 10 occurs thereafter.

A point 10702 illustrated in FIG. 19 indicates the UFB concentration D1 (=2.0e7 pieces/mL) at the time point at which the generation time T1 (=20 seconds) has elapsed. A solid line 10712 indicates an estimation value of the UFB concentration with the generation time.

Additionally, a point 10703 illustrated in FIG. 19 indicates the UFB concentration D2 (=3.6e7 pieces/mL) at the time point at which the generation time T2 (=40 seconds) has elapsed, and a broken line 10713 indicates a measurement value of a UFB concentration that is changed (increased) with the generation time.

In this case, since the UFB concentration D2 is a smaller value than the UFB progress concentration (=4.0e7 pieces/mL) at the time point at which the generation time T2 (=40 seconds) has elapsed, the determination result in S313 is Yes, and the UFB generation speed is increased in S315.

The increased amount of the UFB concentration in 20 seconds in the generation time T1 to T2 is 1.6e7 pieces/mL (=(3.6e7 pieces/mL)−(2.0e7 pieces/mL)). According to this increased amount, it is estimated that the number of the drivable heating elements is about 80 million pieces.

In this embodiment, the increase in the UFB generation speed is made by increasing the driving frequency of the heating elements 10. The unachieved UFB amount at the time point at which the generation time T2 (=40 seconds) has elapsed is about 4.0e6 pieces/mL ((4.0e7 pieces/mL)−(3.6e7 pieces/mL)). Therefore, in the following generation time T2 (40 seconds) to T3 (60 seconds), 24 million pieces/mL (=(2.0e7 pieces/mL)+(4.0e6 pieces/mL)), which is the initially assumed generation amount plus the shortage, are generated. Therefore, the driving frequency is increased 1.5 times to be 15 kHz. A dashed-dotted line 10714 in FIG. 19 indicates the UFB concentration estimation value with the elapse of the generation time.

A point 10704 illustrated in FIG. 19 indicates a UFB concentration D3 (=6.0e7 pieces/mL) at a time point at which the generation time T3 (=60 seconds) has elapsed, and the dashed-dotted line 10714 indicates the UFB concentration estimation value with the elapse of the generation time. In this case, since the UFB concentration D3 is the same value as the UFB progress concentration (=60 million pieces/mL) at the time point at which the generation time T3 (=60 seconds) has elapsed, both the determination results in the determination processing in S313 and S314 are No, and the processing is continued while maintaining the UFB generation speed. A dashed-dotted line 10715 in FIG. 19 indicates the UFB concentration estimation value that is increased with the generation time.

Next, a point 10705 illustrated in FIG. 19 indicates a UFB concentration D4 (=8.4e7 pieces/mL) at a time point at which generation time T4 (=80 seconds) has elapsed, and the dashed-dotted line 10715 indicates the UFB concentration estimation value along with the elapsed time.

In this case, the UFB concentration D4 is a greater value than the UFB progress concentration (=8.0e7 pieces/mL) at the time point at which the elapsed time T4 (=80 seconds) has elapsed. Accordingly, the determination result in the determination processing in S313 is No, while the determination result in the determination processing in S314 is Yes, and the UFB generation speed is reduced in S316. This processing is performed as below.

First, the increased amount of the UFB concentration in 20 seconds of the generation time T3 to T4 is 2.4e7 pieces/mL (=(8.0e7 pieces/mL)−(6.0e7 pieces/mL)). According to this increased amount, it is estimated that the number of operating heating elements is about 8.0e7 pieces.

In this embodiment, the reduction in the UFB generation speed is made by reducing the driving frequency of the heating elements 10. The exceeded UFB amount at the time point at which the generation time T4 (=80 seconds) has elapsed is about 4.0e6 pieces/mL (=(8.4e7 pieces/mL)−(8.0e7 pieces/mL)). Therefore, 1.6e7 pieces/mL (=(2.0e7 pieces/mL)−(4.0e6 pieces/mL), which is obtained by subtracting the excess from the initially assumed generation amount, are generated from the following generation time T4 (80 seconds) to T_tgt (100 seconds). Therefore, the driving frequency of the heating elements 10 is increased 1.0 times to be 10 kHz. A dashed-two dotted line 10716 illustrated in FIG. 19 indicates the UFB concentration estimation value along with the elapsed time.

With such control being made, the UFB concentration estimation value finally reaches a value indicated by the point 10701 in FIG. 19. This point 10701 indicates a UFB progress concentration D_tgt (=1.0e8 pieces/mL) at the elapsed time T_tgt (100 seconds).

If the determination result in the determination processing in S312 in FIG. 18 is Yes, the UFB generation is terminated in S318. Thereafter, in S319, the circulation valve 451 is closed, and in S320, the discharge valve 433 is opened to discharge the generated UFB-containing liquid into the collecting unit 500. With the above procedure, a series of the generation processing for the UFB-containing liquid is terminated.

Thus, according to this embodiment, it is possible to estimate the UFB generation speed by measuring the UFB concentration, and the generation speed by the heating elements is controlled based on the measurement result of the UFB concentration. Consequently, it is possible to make the actual UFB generation time close to the target time and to make the control of the UFB concentration and the estimation on the required time with higher accuracy.

Note that, in this embodiment, the example in which the UFB generation speeds in S315 and S316 are controlled by controlling the driving frequency of the heating elements 10 is described. However, the control method for the UFB generation speed is not limited to the method of controlling the driving frequency, and another control method may be used, or multiple control methods may be combined with each other.

Now, combination examples of the number of the drivable heating elements used and the UFB generation speed are indicated in Table 3.

TABLE 3

| Target UFB | 100,000,000 pieces/ml | | | | |
|---|---|---|---|---|---|
| Concentration | | | | | |
| Target Amount | 1,000 ml | | | | |
| of UFB- | | | | | |
| Containing | | | | | |
| Liquid | | | | | |
| Generated | | | | | |
| Required | 100,000,000,000 pieces | | | | |
| Number of UFBs | | | | | |
| Number of UFBs | 10 pieces/driving | | | | |
| Generated Per | | | | | |
| Driving of | | | | | |
| Heating | | | | | |
| Elements | | | | | |
| Number of Times | 10,000 times/second | | | | |
| of Driving | | | | | |
| Heating Elements | | | | | |
| Per Second | | | | | |
| Number of | 10,000 pieces | 9,000 pieces | 8,000 pieces | 7,000 pieces | 6,000 pieces |
| Heating | | | | | |
| Elements Driven | | | | | |
| Number of Usbs | 1,000,000,000 | 900,000,000 | 800,000,000 | 700,000,000 | 600,000,000 |
| Generated Per | pieces | pieces | pieces | pieces | pieces |
| Second | | | | | |
| Estimated | 100 seconds | 111 seconds | 125 seconds | 143 seconds | 167 seconds |
| Number of | | | | | |
| Seconds To | | | | | |
| Reach Target | | | | | |
| Number of UFBs | | | | | |
| Estimated Time | 0 | 0 | 0 | 0 | 0 |
| [hour] | | | | | |
| Estimated Time | 1 | 1 | 2 | 2 | 2 |
| [minute] | | | | | |
| Estimated Time | 40 | 51 | 5 | 23 | 47 |
| [second] | | | | | |

In general, the number of the drivable heating elements is likely to be reduced with the UFB generation operation due to the loss of the heating function of the heating elements. For this reason, it is also effective to set a condition in which only eight thousand pieces of the heating elements out of 10 thousand pieces of the heating element are used first as the initial setting. For example, in S315, nine thousand pieces of the heating elements are used to increase the UFB generation speed, and 10 thousand pieces of the heating elements are used to further increase the UFB generation speed. Additionally, in S316, seven thousand pieces of the heating elements are used to reduce the UFB generation speed, and six thousand pieces of the heating elements 10 are used to further reduce the UFB generation speed. Thus, it is also possible to adjust the UFB generation speed depending on the number of the heating elements used. Note that, in a case of making such control, it is possible to equalize the consumption of the heating elements and to extend the length of life of the heating elements by sequentially changing the combination of the initially set heating elements every UFB generation operation.

Additionally, combination examples of the number of times of driving (driving frequency) per second of the heating elements and the UFB generation speed are indicated in Table 4.

TABLE 4

| Target UFB | 100,000,000 pieces/ml | | | | |
|---|---|---|---|---|---|
| Concentration | | | | | |
| Target | 1,000 ml | | | | |
| Amount of | | | | | |
| UFB Water | | | | | |
| Generated | | | | | |
| Required | 100,000,000,000 pieces | | | | |
| Number of | | | | | |
| UFBs | | | | | |
| Number of | 10 pieces/driving | | | | |
| UFBs | | | | | |
| Generated | | | | | |
| Per Driving | | | | | |
| of Heating | | | | | |
| Elements | | | | | |
| Number of | 10,000 | 9,000 | 8,000 | 7,000 | 6,000 |
| Times of | times/second | times/second | times/second | times/second | times/second |
| Driving | | | | | |
| Heating | | | | | |
| Elements Per | | | | | |
| Second | | | | | |
| Number of | 10,000 | 10,000 | 10,000 | 10,000 | 10,000 |
| Heating | pieces | pieces | pieces | pieces | pieces |
| Elements | | | | | |
| Driven | | | | | |
| Number of | 1,000,000,000 | 900,000,000 | 800,000,000 | 700,000,000 | 600,000,000 |
| Usbs | pieces | pieces | pieces | pieces | pieces |
| Generated | | | | | |
| Per Second | | | | | |
| Estimated | 100 seconds | 111 seconds | 125 seconds | 143 seconds | 167 seconds |
| Number of | | | | | |
| Seconds To | | | | | |
| Reach Target | | | | | |
| Number of | | | | | |
| UFBs | | | | | |
| Estimated | 0 | 0 | 0 | 0 | 0 |
| Time [hour] | | | | | |
| Estimated | 1 | 1 | 2 | 2 | 2 |
| Time | | | | | |
| [minute] | | | | | |
| Estimated | 40 | 51 | 5 | 23 | 47 |
| Time | | | | | |
| [second] | | | | | |

It is obvious from the above Table 4 that it is possible to control the number of generated UFBs by controlling the driving frequency of the heating elements.

Moreover, an example in which the UFB generation speed (the number of generated UFBs per second) is maintained constant by combinations of the driving frequency of the heating elements and the number of the heating elements is indicated in Table 5.

TABLE 5

| Target | 100,000,000 pieces/ml | | | | |
|---|---|---|---|---|---|
| UFB | | | | | |
| Concentration | | | | | |
| Target | 1,000 ml | | | | |
| Amount | | | | | |
| of UFB | | | | | |
| Water | | | | | |
| Generated | | | | | |
| Required | 100,000,000,000 pieces | | | | |
| Number | | | | | |
| of UFBs | | | | | |
| Number | 10 pieces/driving | | | | |
| of UFBs | | | | | |
| Generated | | | | | |
| Per | | | | | |
| Driving of | | | | | |
| Heating | | | | | |
| Elements | | | | | |
| Number | 10,000 | 12,500 | 20,000 | 40,000 | 100,000 |
| of Times | times/second | times/second | times/second | times/second | times/second |
| of Driving | | | | | |
| Heating | | | | | |
| Elements | | | | | |
| Per | | | | | |
| Second | | | | | |
| Number | 10,000 pieces | 8,000 pieces | 5,000 pieces | 2,500 pieces | 1,000 pieces |
| of Heat | | | | | |
| Generation | | | | | |
| Elements | | | | | |
| Driven | | | | | |
| Number | 1,000,000,000 | 1,000,000,000 | 1,000,000,000 | 1,000,000,000 | 1,000,000,000 |
| of Usbs | pieces | pieces | pieces | pieces | pieces |
| Generated | | | | | |
| Per | | | | | |
| Second | | | | | |
| Estimated | 100 seconds | 100 seconds | 100 seconds | 100 seconds | 100 seconds |
| Number | | | | | |
| of | | | | | |
| Seconds | | | | | |
| To Reach | | | | | |
| Target | | | | | |
| Number | | | | | |
| of UFBs | | | | | |
| Estimated | 0 | 0 | 0 | 0 | 0 |
| Time | | | | | |
| [hour] | | | | | |
| Estimated | 1 | 1 | 1 | 1 | 1 |
| Time | | | | | |
| [minute] | | | | | |
| Estimated | 40 | 40 | 40 | 40 | 40 |
| Time | | | | | |
| [second] | | | | | |

As indicated in the above Table 5, it is possible to maintain the number of the UFBs generated constant by controlling the driving frequency of the heating elements according to the number of the heating elements driven. That is, if the number of the usable heating elements is relatively great, the driving frequency of each heating element is reduced, and if the number of the usable heating elements is relatively small, the driving frequency of each heating element is increased. With this, it is possible to obtain the constant number of the UFBs generated also in a case where a change occurs in the number of the usable heating elements. Note that, in a case of making such control, it is possible to set a proper driving frequency by separately detecting the number of the drivable heating elements. As for the detection method for the drivable heating elements, it is possible to adopt various methods such as a method of detecting heat that is generated while driving the heating elements and a method of detecting a sound from bubbling and bubble disappearance.

### Fourth Embodiment

In the above-described embodiments using the T-UFB method, it is possible to make the concentration of the UFB-containing liquid to be generated close to the target UFB concentration with high accuracy. Therefore, there is a concern that, if the setting of the target UFB concentration of the UFB-containing liquid is excessively high, the UFB-containing liquid of a high concentration may be generated according to the high setting value. To deal with this, the generating apparatus for the UFB-containing liquid in this embodiment has a function of limiting the UFB concentration to a proper concentration if the user sets an excessively high target UFB concentration.

The reason why such a concentration limiting function is provided is because the generating apparatus for the UFB-containing liquid in the above-described embodiment using the T-UFB method is capable of holding a gas exceeding a saturation solubility in a liquid (for example, water). With the device described in the above-described embodiment, it is possible to improve the UFB concentration as more as the generation time is increased, and as a result, it is possible to generate a UFB-containing liquid that holds a gas having a high concentration that has never existed before. The UFB-containing liquid having the high UFB concentration as described above has various effectiveness; however, the UFBs having an excessive concentration has also a possibility of reducing the effects, and therefore it is favorable to limit the UFB concentration to a proper UFB concentration by a concentration limiting function described below.

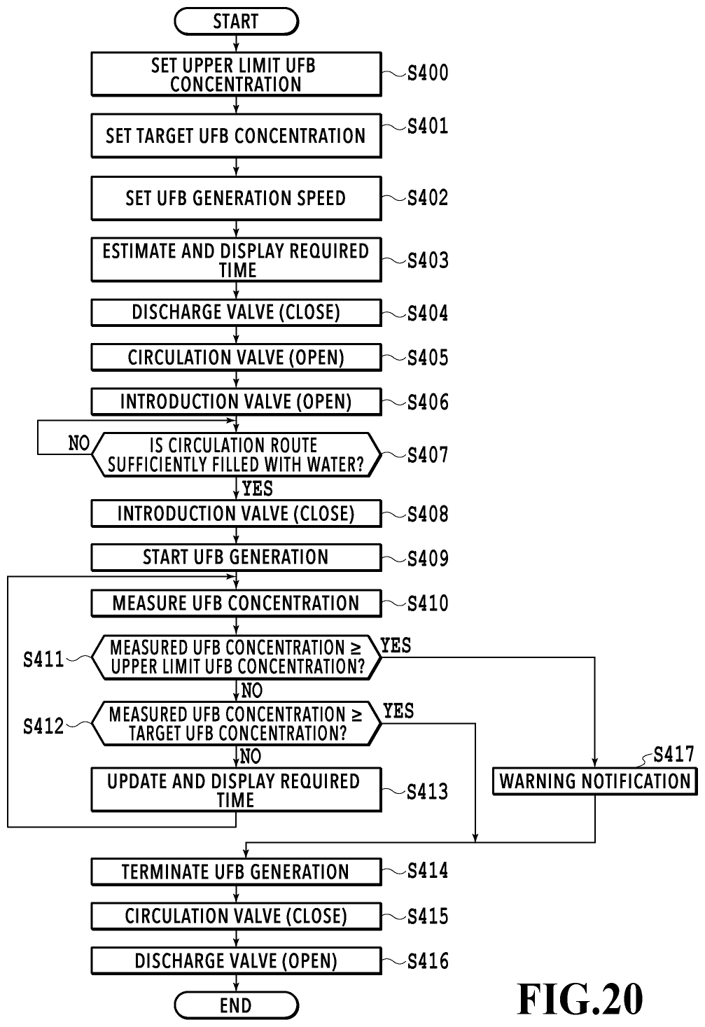

FIG. 20 is a flowchart illustrating generation processing for the UFB-containing liquid executed in this embodiment.

In FIG. 20, S401 to S410 are similar to S101 to S110 in FIG. 13, and S412 to S416 are similar to S111 to S115 in FIG. 13; for this reason, duplicated descriptions are omitted.

In S400, an upper limit UFB concentration is set in order not to allow the generation of excessive UFB concentration. This setting processing for the upper limit UFB concentration is performed by reading an upper limit UFB concentration that is stored in the RAM or the like in advance. Otherwise, it is also possible to set an upper limit value that is designated by the user from multiple types of upper limit values determined in advance.

In S411, whether the measured UFB concentration that is measured in S410 is equal to or more than the upper limit UFB concentration set in S400 is determined. If the determination result is No, the process proceeds to S412, and the processing is continued. On the other hand, if the determination result of the determination processing in S411 is Yes, the process proceeds to S417. In S417, a warning notification is made to the user by using a monitor or a warning lamp. It may be a method of making a sound or making a warning notification to another device through a network. Thereafter, the processing in S414 to S416 is performed. This processing is similar to the processing in S113 to S115 in FIG. 13.

The upper limit UFB concentration set in S400 is favorable to be set depending on the type of the gas generated as the UFBs. Additionally, instead of setting the upper limit UFB concentration in S400, it is also possible in the setting processing for the target UFB concentration performed in S401 to adopt a method in which a warning notification is made if the set concentration exceeds the upper limit UFB concentration to not allow for the setting of the target UFB concentration.

As described above, in this embodiment, the upper limit UFB concentration is set, and a warning notification is made if a UFB concentration exceeding the upper limit UFB concentration is detected to stop the UFB generation. With this, it is possible to prevent manufacturing of the UFB-containing liquid having an excessively high UFB concentration by the T-UFB method before happens. Note that, the upper limit UFB concentration is favorable to be set properly depending on the concentration of the created UFB-containing liquid, the working environment, the usage environment of the UFB-containing liquid, and the like.

### Fifth Embodiment

Next, a fifth embodiment of the UFB generating apparatus according to the present invention is described.

The UFB-containing liquid generating apparatus according to the T-UFB method of the above-described first to fourth embodiments is assumed for a use case in which the UFB-containing liquid reserved in the collecting unit 500 is stored into some sealed container and is actually used after the UFB-containing liquid is transferred to a usage place. However, the present invention is not limited to the application to the above-described use case. For example, the present invention is also applicable to a use case in which, for example, the UFBs are generated by the T-UFB method in a liquid supplied from a liquid route, and the UFB-containing liquid generated is directly discharged into a predetermined usage position. Hereinafter, descriptions are given while a T-UFB generating apparatus that is used as a water purifier and a T-UFB generating apparatus that is used in a washing machine are adopted as an example of a T-UFB generating apparatus for the above use case to which the present invention is applied.

### <T-UFB Generating Apparatus Used as Water Purifier>

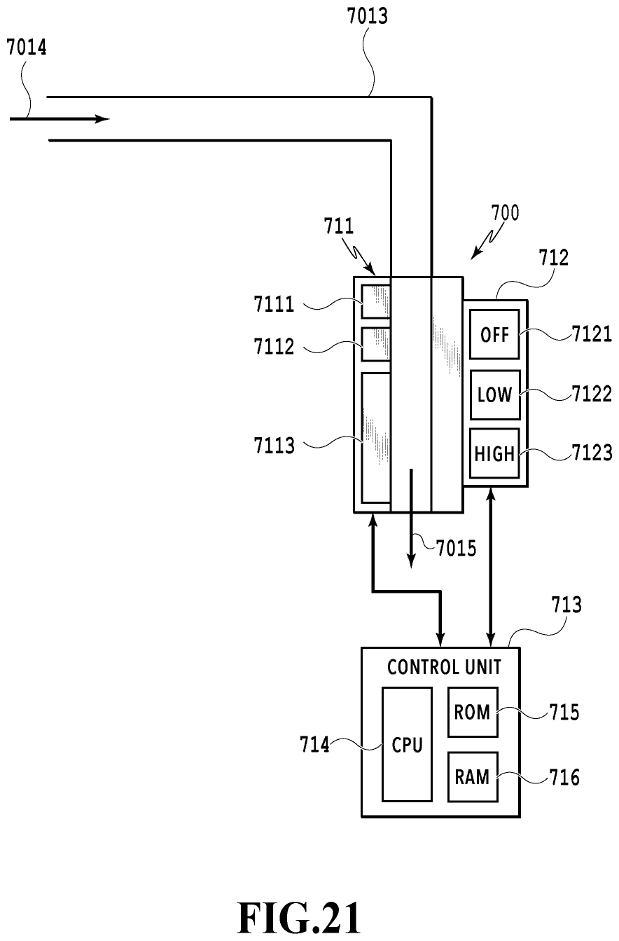

FIG. 21 is a diagram schematically illustrating the T-UFB generating apparatus that is used as a water purifier. In FIG. 21, a T-UFB generating apparatus 700 includes a T-UFB generating unit 711 (hereinafter, simply called a unit as well) attached to the tip of a faucet of a water pipe and purifies tap water by applying the UFBs to the water (liquid) flowing from the faucet of the water pipe into the unit 711. In the unit 711, a liquid detection sensor (liquid detection unit) 7111 that detects whether there is water, a flow speed sensor (flow speed detection unit) 7112 that detects the speed of water flow, and a heating unit 7113 that generates the T-UFBs into the water flowing therein are provided close to each other. Additionally, the unit 711 is provided with a control unit 713 that controls driving of the heating unit 7113.

Moreover, an outer surface of the unit 711 is provided with an operation display unit 712 for setting operations of the T-UFBs. The operation display unit 712 is provided with an OFF setting button 7121, a LOW setting button 7122, and a HIGH setting button 7123. In this case, the OFF setting button 7121 is a button for making an instruction to stop the UFB generation, and the LOW setting button 7122 is a button for making an instruction to generate the UFBs having a relatively low concentration. Additionally, the HIGH setting button 7123 is a button for making an instruction to generate the UFBs having a relatively high concentration. With these buttons being pressed, each button transmits the instruction to the control unit 713, and the control unit 713 controls a not-illustrated driving unit that drives the heating unit 7113 according to the instruction.

Moreover, in this example, a not-illustrated light-emitting element is mounted inside each of the buttons 7121, 7122, and 7123. The light-emitting element mounted in each button emits light by the driving control of the control unit 713 in a case where the button is in an effective state such that the user can be notified of the situation of the button operation. Furthermore, both the liquid detection sensor 7111 and flow speed sensor 7112 are connected to a CPU 714, and a detection signal from each sensor is inputted to the CPU 714.

Note that, in FIG. 21, 7013 indicates a piping portion of a water pipe facility. The piping portion 7013 is provided with a not-illustrated valve, and it is possible to perform supplying and stopping of the tap water to the UFB generating unit 711 and adjustment of the supply amount by adjusting the opening degree of the valve. Note that, the tap water flows and moves in the piping portion 7013 along directions indicated by arrows 7014 and 7015.

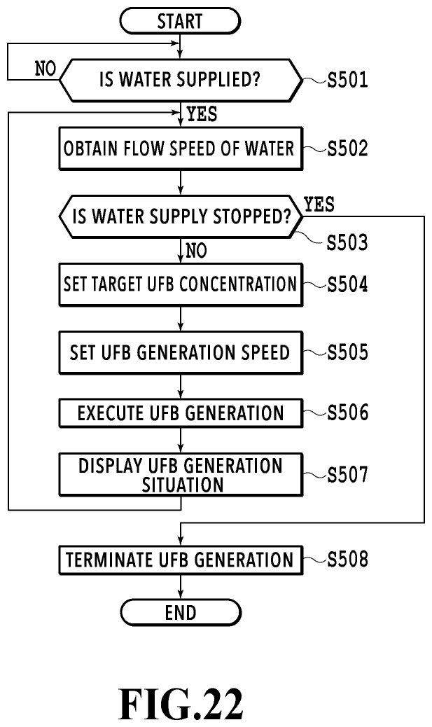

Next, operations in this example are described with reference to the flowchart illustrated in FIG. 22. Note that, a series of processing indicated in the flowchart in FIG. 22 used in the following descriptions is performed with the CPU deploying and executing a program code stored in the ROM into the RAM. Otherwise, a part of or all the functions in FIG. 22 may be implemented by hardware such as an ASIC, an electronic circuit, and the like. Note that, the sign “S” in the description of each processing means a step in the description of each processing.

In S501, first, the liquid detection sensor 7111 detects whether there is water. In this process, if the tap water is in a supply stop state, the detection result by the liquid detection sensor 7111 is “there is no water”, and if the tap water is supplied, the detection result by the liquid detection sensor 7111 is “there is water”. If the detection result is there is no water, the processing in S501 is repeated. On the other hand, if the detection result in S501 is “there is water”, the process proceeds to S502.

In S502, a flow speed of the water supplied to the UFB generating unit 711 is detected by the flow speed sensor 7112. The flow speed sensor 7112 may be the one adopting a mechanistic detection method using a water wheel or a spring, or may be the one adopting an electric detection method using pressure.

In S503, whether the flow speed detected by the flow speed sensor 7112 is substantially in a supply stop state is detected. If the user closes the valve to stop using the water pipe, the detection result by the flow speed sensor 7112 is “supply is stopped”. Then, if the detection result is supply is stopped, the process proceeds to S508, the UFB generation by the heating unit 7113 is terminated, and the series of processing is terminated. On the other hand, if the detection result is not supply is stopped, the process proceeds to S504.

In S504, the target UFB concentration is set. In this case, the concentration setting is performed based on the setting by the operation display unit 712 illustrated in FIG. 21. In this example, the target UFB concentration is set as below based on which button is pressed at last.
The OFF setting button 7121 is pressed at last→target UFB concentration=0
The LOW setting button 7122 is pressed at last→target UFB concentration=one million pieces/mL
The HIGH setting button 7123 is pressed at last→target UFB concentration=two million pieces/mL

Next, in S505, the UFB generation speed is set. The UFB generation speed is set depending on the flow speed of the water supplied and the target UFB concentration. That is, in order to achieve the target UFB concentration, it is required to increase the UFB generation speed as the flow speed is faster.

In this example, it is assumed that:
the number of the heating elements is 1000 pieces; and
the number of the UFBs generated when one heating element is driven one time is 10 pieces, and

the target UFB concentration is achieved by controlling the number of times of driving (driving frequency) of the heating elements per second.

A list of flow speeds, UFB generation speeds required to achieve the target UFB generation concentration on the operation display unit 712, and the number of times of driving the heating unit 7113 per second is indicated in Table 6.

TABLE 6
Number of Times of Driving Heating Unit Per Second to Achieve Required UFB
Generation Speed

| Number of Times of | | Flow Speed (mL/second) | | | | |
|---|---|---|---|---|---|---|
| Driving Per Second | | 10 | 20 | 30 | 40 | 50 |
| Target UFB | OFF | 0 | 0 | 0 | 0 | 0 |
| Concentration | LOW: | 1,000 | 2,000 | 3,000 | 4,000 | 5,000 |
| | One | | | | | |
| | Million | | | | | |
| | Pieces/mL | | | | | |
| | HIGH: | 2,000 | 4,000 | 6,000 | 8,000 | 10,000 |
| | Two | | | | | |
| | Million | | | | | |
| | Pieces/mL | | | | | |

The number of times of driving indicated in the above Table 6 is calculated as below.

For example, in a case where the flow speed of the water is 10 (mL/seconds), and the target UFB concentration is LOW: one million (pieces/mL), the UFB generating apparatus 700 requires the UFB generation speed per second of:

10 (mL/seconds)×one million (pieces/mL)=10 million (pieces/second).

With the heating unit 7113 being driven one time,

1000×10=10 thousand (pieces/number of time of driving)

of the UFBs are generated; therefore, the number of times driving the heating unit 7113 per second that should be performed to achieve the required UFB generation speed is:

10 million (pieces/second)±10 thousand (pieces/number of time of driving)=1000 (number of times of driving/second).

In S507, the UFB generation is executed according to the UFB generation speed set in S505. Additionally, in S506, the UFB generation situation is displayed, and the process returns to S502. Thereafter, the processing in S502 to S507 is continued until the determination result of S503 becomes “supply is stopped”.

As described above, the operation display unit 712 includes the light-emitting element mounted inside each of the buttons 7121, 7122, and 7123. In S507, blinking in green of one of these buttons 7121, 7122, and 7123 indicates that it is in the middle of the UFB generation. On the other hand, in a situation in which the target UFB concentration cannot be achieved due to an excessive flow rate of the water supplied, the selected button blinks in red to urge the user to deal with the situation by reducing the flow speed and the like.

If the user reduces the flow speed, the reduced flow speed is detected in the following S502, and the UFB generation speed is reset based on the reduced flow speed in S505. Then, if it is in a situation in which the target UFB concentration can be achieved, the emission color of the selected button is changed into green.

Additionally, if the selected button is changed from the HIGH setting button 7123 to the LOW setting button 7122, in S505, the UFB generation speed is reset based on the reduced target UFB concentration.

Moreover, if the user increases the flow speed or increases the target UFB concentration while the emission color of the button is green, the emission color of the button may be changed into red due to the resetting of the UFB generation speed in S505.

A list of a relationship between flow speeds, the actual number of times of driving (actual number of times of driving) the heating unit 7113 per second according to the setting of the operation display unit 712, and the emission color of the button in a case where an upper limit of the number of times of driving the heating unit 7113 per second is 4000 times is indicated in Table 7.

TABLE 7
Actual Number of Times of Driving and Emission Color of Button in Case where Upper
Limit of Number of Times of Driving is 4000 Times

| Number of Times of | | | | | | |
|---|---|---|---|---|---|---|
| Driving per Second and | | Flow Speed (mL/second) | | | | |
| Emission Color of Button | | 10 | 20 | 30 | 40 | 50 |
| Target UFB | OFF | 0 (white) | 0 (white) | 0 (white) | 0 (white) | 0 (white) |
| Concentration | LOW: | 1000 | 2000 | 3000 | 4000 | 4000 |
| | One | (green) | (green) | (green) | (green) | (red) |
| | Million | | | | | |
| | Pieces/ml | | | | | |
| | HIGH: | 2000 | 4000 | 4000 | 4000 | 4000 |
| | Two | (green) | (green) | (red) | (red) | (red) |
| | Million | | | | | |
| | Pieces/ml | | | | | |

If the user presses the LOW setting button 7122 to set the target UFB concentration to LOW (one million pieces/mL), it is possible to achieve the target UFB concentration until the flow speed becomes 40 mL/seconds. Therefore, if the flow speed detected by the flow speed sensor 7112 is equal to or lower than 40 mL/seconds, the CPU 714 sets the actual number of times of driving to the required number of times of driving and makes the control to set the emission color of the LOW setting button 7122 to green. However, if the flow speed exceeds 40 mL/second, there is required the number of times of driving that exceeds 4000 times/seconds as the upper limit. Therefore, if the flow speed detected by the flow speed sensor 7112 exceeds 40 mL/second, the CPU 714 sets the actual number of times of driving to 4000 times/second as the upper limit and makes the control to set the emission color of the LOW setting button 7122 to red.

On the other hand, if the user presses the HIGH setting button 7123 to set the target UFB concentration to HIGH (two million pieces/mL), it is possible to achieve the target UFB concentration until the flow speed becomes 20 mL/second. Therefore, if the flow speed detected by the flow speed sensor 7112 is equal to or lower than 20 mL/second, the CPU 714 sets the actual number of times of driving to the required number of times of driving and makes the control to set the emission color of the HIGH setting button 7123 to green. However, if the flow speed exceeds 20 mL/second, there is required the number of times of driving that exceeds 4000 times/second as the upper limit. Therefore, if the flow speed detected by the flow speed sensor 7112 exceeds 20 mL/second, the CPU 714 sets the actual number of times of driving to 4000 times/second as the upper limit and sets the emission color of the HIGH setting button 7123 to red.

If the OFF setting button 7121 is pressed, and the UFB generation is set to OFF, the emission color of the OFF setting button 7121 is set to white in order to clearly show the user that the UFB generation is in the OFF state.

Thus, in this example, the user is able to visually figure out whether the UFB-containing liquid having a desired UFB concentration is being generated and whether the UFBs are being generated based on the emission color of the button.

Additionally, in this example, the user is notified of the driving situation of the device by the light-emitting element mounted in the button; however, it is also possible to provide a display unit that is capable of displaying more amount of information on the operation display unit 712. For example, a liquid crystal display, an organic EL display, or the like may be provided in the operation display unit 712 to display information such as the actual UFB generation concentration.

Moreover, it is also possible to mount a not-illustrated communication unit in the UFB generating unit 711 to transmit information such as the above-described actual UFB generation concentration to an external device such as a smartphone and display it on the external device side.

As described above, in this example, with the UFB generation speed being set depending on the flow speed, it is possible to provide the UFB-containing liquid having a desired UFB concentration to the user. Additionally, depending on the set flow speed or UFB concentration, the desired UFB concentration may not be achieved in some cases; however, in such a case, it is possible to dynamically notify the user of the unachievable situation.

Moreover, in this example, with the generation of the UFBs in the heating unit 7113 being stopped by pressing the OFF button, it is possible to keep flowing the supplied liquid (in this case, tap water) itself. In this example, there is no need to change the flow passage of the liquid between a case of generating the UFBs and a case of not generating the UFBs, and the flowing and moving of the liquid can be maintained continuously. Consequently, it is possible to simplify a flow passage configuration and to achieve the downsizing and cost-reduction of the device. In contrast, in a conventional UFB generating apparatus using a venture tube and the like, in order to make it possible to perform the switching between a liquid not containing the UFBs and the UFB-containing liquid while maintaining the flowing and moving of the liquid, there are required at least two routes and a valve and the like for switching between the routes. That is, there are required a route passing through a UFB generating unit, a bypass flow passage not passing through the UFB generating unit, and a valve that selectively switches between the routes, and this causes the device to be greater in size and the cost to be higher than this example.

Furthermore, the sterilizing effect of the UFB-containing liquid is focused in this example, and thus the example in which a water purifier includes the T-UFB generating apparatus that can obtain a high UFB concentration is described. However, the T-UFB generating apparatus according to the present invention is not limited to a water purifier, and application to another UFB generating apparatus that requires the modulation of the UFB generation speed depending on a varying flow speed or a desired UFB concentration is also effective.

### <T-UFB Generating Apparatus Mounted in Washing Machine>

Next, a T-UFB generating apparatus that is mounted in a washing machine is described. As for the T-UFB generating apparatus that is mounted in a washing machine, the configuration of stably supplying the UFBs of a predetermined UFB concentration to the water supplied is also similar to the T-UFB generating apparatus 700 illustrated in FIG. 21. However, in a T-UFB generating apparatus 800 in this example, it is required to generate a UFB-containing liquid that is adapted to a function unique to a washing machine. The function unique to a washing machine may be:

washing: to remove stains and the like attached to clothes;

tub cleaning: to remove black mold attached to a washing tub;

and the like, for example.

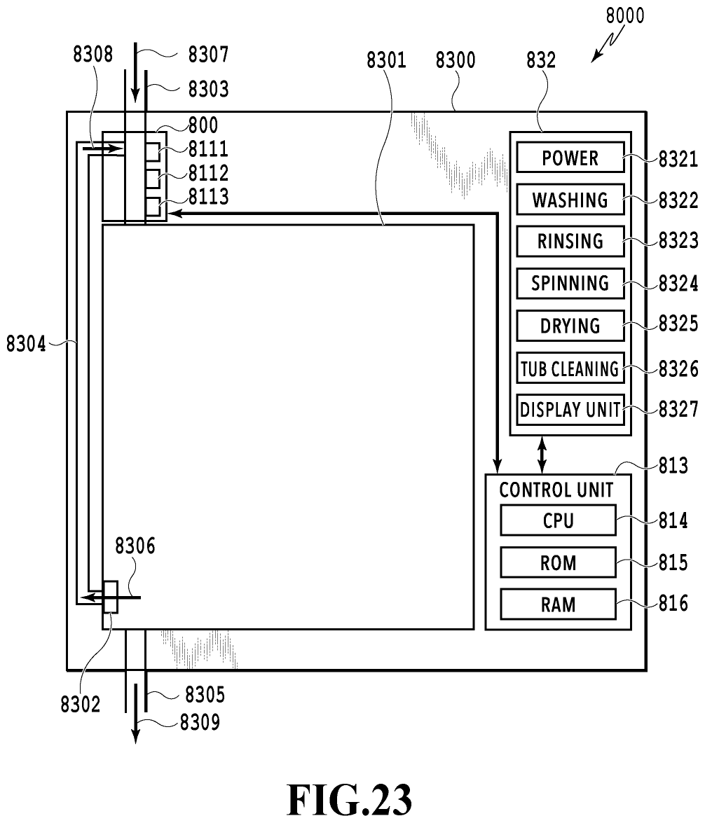

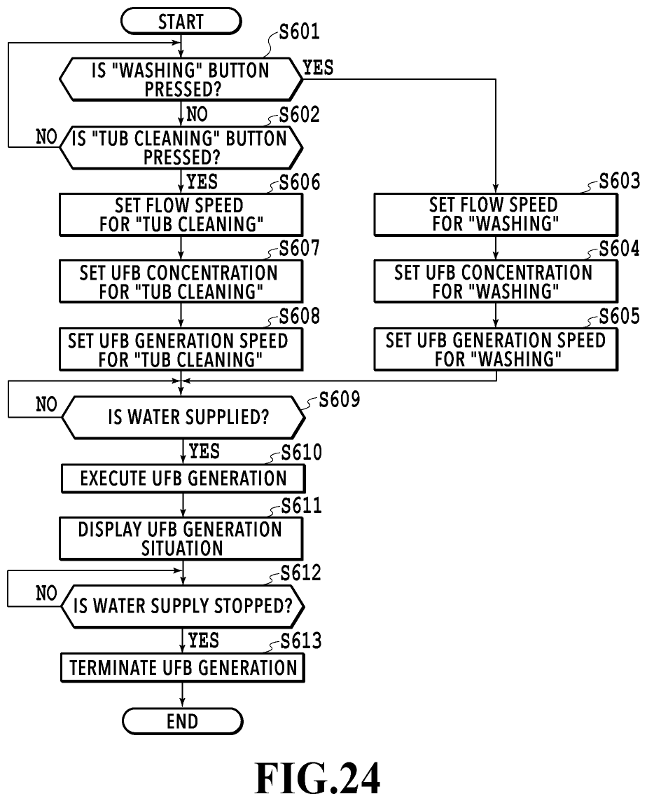

Therefore, a UFB-containing liquid having a UFB concentration according to these functions is supplied from the T-UFB generating apparatus to improve the functions of the washing machine. Hereinafter, a configuration and operations of the T-UFB generating apparatus used in a washing machine are described with reference to FIGS. 23 and 24.

A washing machine 8000 illustrated in FIG. 23 includes the T-UFB generating apparatus 800 on a water supply side and performs washing of clothes, cleaning of a washing tub, and so on by using the UFB-containing liquid generated therein. A washing machine main body 8300 of this washing machine 8000 is provided with a washing tub 8301. The washing tub 8301 is coupled to the later-described T-UFB generating apparatus 800 that is coupled to a water supply route 8303 and a water discharge route 8305 that discharges water in the washing tub 8301 to the outside. Additionally, the washing tub 8301 is coupled to a reflux route 8304 for circulating the water between the washing tub 8301 and the T-UFB generating apparatus 800, and a discharge port of the reflux route 8304 is provided with a filter 8302 that removes a foreign substance. Note that, arrows 8306 to 8309 in the diagrams indicate directions of the flow of the water streams in the routes.

The washing machine main body 8300 is provided with the T-UFB generating apparatus 800 connected to the above-described water supply route 8303. The T-UFB generating apparatus 800 includes a liquid detection sensor 8111 that detects whether there is water, a flow speed sensor (flow speed detection unit) 8112, a heating unit 8113 that generates the T-UFBs, and the like. The heating unit 8113 includes many heating elements.

Additionally, the washing machine main body 8300 is provided with an operation display unit 832 for setting the operations of the T-UFBs. This operation display unit 832 is provided with not only a power button 8321 for inputting power to the washing machine 8000 but also a button for instructing various operations that can be performed by the washing machine. In this case, a washing button 8322 for instructing washing, a rinsing button 8323 for instructing rinsing, a spinning button 8325 for instructing spinning, a drying button 8324 for instructing drying, a tub cleaning button 8326 for instructing cleaning of the washing tub 8301, and the like are provided.

Additionally, the washing machine main body 8300 is provided with a control unit 813 that controls the operations of the washing machine 8000 and the T-UFB generating apparatus 800. The control unit 813 includes a CPU 814 that controls overall driving units of the washing machine 8000, the T-UFB generating apparatus 800, and so on, the ROM 815, the RAM 816, and the like, and is mounted in a main body unit 8300. The control unit 813 controls operations of the units according to the instructions and the like outputted from the above-described buttons 8321 to 8326.

Next, operations in this example are described with reference to the flowchart illustrated in FIG. 24. Note that, a series of the processing indicated in the flowchart in FIG. 24 used in the following descriptions is performed with the CPU 814 deploying and executing a program code stored in the ROM 815 into the RAM 816. Otherwise, a part of or all the functions in FIG. 24 may be implemented by hardware such as an ASIC, an electronic circuit, and the like. Note that, the sign “S” in the description of each processing means a step in the description of each processing.

If the power button 8321 of the operation display unit 832 is pressed, and power is inputted to the washing machine 8000, the CPU 814 determines whether the washing button 8322 is pressed (S601). In this process, if the determination result is Yes, the process proceeds to processing S603 to S605 in which the driving condition for the UFB generation during the washing is set. In this setting processing, the flow speed for the washing is set in S603, the UFB concentration for the washing is set in S604, and the speed for the UFB generation for the washing is set in S605.

On the other hand, If the determination result in the determination processing in S601 is No, the process proceeds to S602. In S602, whether the tub cleaning button 8326 is pressed is determined, and if the determination result is No, the process returns to the determination processing in S601, and if the determination result is Yes, the process proceeds to processing S606 to S608 in which the driving condition for the UFB generation during the tub cleaning is set. In this setting processing, the flow speed for the tub cleaning is set in S606, the UFB concentration for the tub cleaning is set in S607, and the speed for the UFB generation for the tub cleaning is set in S608.

Thus, in this example, the driving condition during the UFB generation is switched between a case in which the washing button 8322 of the buttons provided in the operation display unit 832 is pressed and a case in which the tub cleaning button 8326 thereof is pressed.

As for a specific description for the switching of the driving condition, the control such as:

washing: UFB concentration upper limit one million (pieces/mL); and

tub cleaning: UFB concentration lower limit 10 million (pieces/mL)

are required, for example. That is, for the case of the washing, it is required to set a predetermined UFB concentration as the upper limit in order to avoid a damage on clothes while removing stains and the like concurrently. On the other hand, for the case of the tub cleaning, since there is no need to take into consideration a damage on clothes, it is favorable to reliably generate the UFBs having a relatively high concentration required to remove black mold and the like.

The T-UFB generating apparatus 800 mounted in the washing machine 8000 in this example has the following specifications.
Number of heating elements provided in heating unit: 10000 pieces
Number of generated UFBs in a case of driving one heating element one time: 10 pieces
Upper limit of number of times of driving/second of each heating element: 4000 times/second

With the above-described specifications, a relationship between the flow speed of the water supplied from the water supply route 8303 and the number of times of driving each heating element for each of the normal washing and the tub cleaning is indicated in Table 8.

TABLE 8
Relationship between Flow Speed and Number of
Times of Driving during Each Operation

| Number of Times of Driving Each | | Flow Speed (mL/second) | |
|---|---|---|---|
| Heating Element Per Second | | 40 | 400 |
| Required UFB | Normal Washing: | 400 | 4,000 |
| Concentration | One Million | | |
| | Pieces/mL | | |
| | Tub Cleaning: 10 | 4,000 | 40,000 (N/A) |
| | Million Pieces/mL | | |

As indicated in Table 8, in the case of the normal washing, it is possible to generate the required UFB concentration in both the cases of the flow speed of 40 mL/second and the flow speed of 400 mL/second.

On the other hand, it is also possible to generate the required UFB concentration in the case of the tub cleaning if the flow speed is 40 mL/second. However, if the flow speed is 400 mL/second, the number of times of driving the heating element per second is required to be 40000 times/second, which exceeds 4000 times/second as the upper limit, and it is impossible to generate the UFB-containing liquid having the required UFB concentration. To deal with this, it is possible to achieve the required UFB concentration in both the cases of the normal washing and the tub cleaning by controlling the flow speed as below:
flow speed during normal washing: 400 mL/second (about 100 seconds for supplying 40 L of UFB-containing liquid); and
flow speed during tub cleaning: 40 mL/second (about 1000 seconds for supplying 40 L of UFB-containing liquid).

As described above, in this example, different driving conditions are set for the washing and the tub cleaning, and processing in S609 to S613 is executed according to the corresponding driving conditions. That is, in S609, whether the water is supplied to the T-UFB generating apparatus 800 is determined based on the detection result by the liquid detection sensor 8111, and If the determination result is Yes, the process proceeds to S610, and if it is No, the determination processing is continued. In S610, the UFB generation operation is executed according to the driving condition set by the setting processing in S603 to S605 or the setting processing in S606 to S608. Then, the UFB generation situation is displayed on the display unit 8327 provided in the operation display unit 832. Thereafter, in S612, whether the supplying of the water is stopped is determined based on the detection result by the flow speed sensor 8112, and If the determination result is No, the determination processing is continued, and If the determination result is Yes, a series of the UFB generation processing is terminated.

In this example, the example in which the UFB concentration required for each of the cases of the normal washing and the tub cleaning is generated by controlling the flow speed is described. However, it is also possible to adopt a method of improving the UFB concentration by circulating the water without changing the flow speed during the tub cleaning from the flow speed during the normal washing.

Additionally, in a case of focusing on the filling speed of water into the washing tub 8301, the water may be circulated while the flow speed of the water is set to a flow speed of the water equal to or greater than the flow speed calculated from the target UFB concentration and the UFB generation performance in both the cases of the normal washing and the tub cleaning. With this, it is also possible to improve the actual UFB concentration.

### Sixth Embodiment

Next, a UFB generating apparatus in a sixth embodiment of the present invention is described. This embodiment includes a T-UFB generating apparatus that is capable of generating the UFB-containing liquid having a desired UFB concentration by generating the UFBs in a liquid reserved in a liquid reserve container.

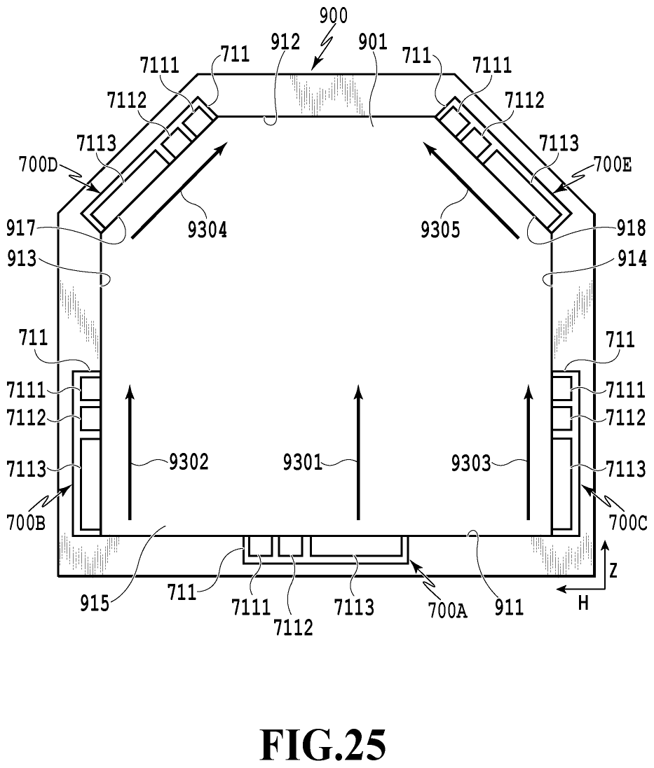

FIG. 25 is a longitudinal sectional side view schematically illustrating a liquid reserve container 900 in which T-UFB generating apparatuses 700A to 700E are arranged in this embodiment. Note that, in FIG. 25, Z indicates a vertical direction, and H indicates a horizontal direction. In the liquid reserve container 900, a reserve chamber 901 forming a space in which the liquid can be reserved is formed. The reserve chamber 901 has a multifaceted shape. In this embodiment, the reserve chamber 901 is formed of eight inner surfaces, which are a bottom surface 911, an upper surface 912, four side surfaces (left side surface 913, right side surface 914, rear side surface 915, and front side surface (not illustrated)), a left inclined surface 917, and a right inclined surface 918. The bottom surface 911 and the upper surface 912 are formed so as to be substantially parallel to a horizontal plane while the liquid reserve container 900 is provided on the horizontal plane. Additionally, the reserve chamber 901 is configured such that a predetermined liquid (for example, water) is supplied to the reserve chamber 901 from a supply port not illustrated, and the supply port can be maintained in a closed state after a certain amount is supplied.

In the reserve chamber 901, the T-UFB generating apparatus 700A is arranged along the bottom surface 911, the right and left side surfaces 913 and 914, and the right and left inclined surfaces 917 and 918, respectively. That is, the total number of five T-UFB generating apparatuses 700A to 700E are arranged in the reserve chamber 901. As with the T-UFB generating apparatus 700 illustrated in FIG. 21 described above, in each of the T-UFB generating apparatuses 700A to 700E, the liquid detection sensor 7111, the flow speed sensor 7112, and the heating unit 7113 are provided in positions close to each other. The sensors 7111 and 7112 and the heating unit 7113 are arranged in a state in which they can be in contact with the liquid reserved in the reserve chamber 901. Note that, the T-UFB generating apparatuses 700A to 700E are all connected to a not-illustrated control unit, and the driving of the heating elements of the heating unit 7113 is controlled by the control unit.

In the liquid reserve container 900 having the above-described configuration, the liquid detection sensor 7111 of each of the five T-UFB generating apparatuses 700A to 700E detects whether there is water. When the reserve chamber 901 is supplied with water, first, the liquid detection sensor 7111 of the T-UFB generating apparatus 700A arranged on the bottom surface 911 detects the water and transmits a detection signal to the control unit. The control unit that receives the detection signal drives the heating unit 7113 of the T-UFB generating apparatus 700A to generate the UFBs.

Thereafter, when the liquid level of the water supplied to the reserve chamber 901 is increased, the water is brought into contact with the liquid detection sensor 7111 of each of the T-UFB generating apparatuses 700B and 700C arranged on the right and left side surfaces 913 and 914, and a detection signal is outputted from each sensor. The control unit receiving this detection signal drives the heating units 7113 of the T-UFB generating apparatus 700B and 700C arranged on the right and left two surfaces. With this configuration, the UFBs are generated from the heating unit 7113 of each of the T-UFB generating apparatuses 700A to 700C.

Thereafter, when the liquid level of the water is further increased, the water is brought into contact with the liquid detection sensor 7111 of each of the T-UFB generating apparatuses 700D and 700E arranged on the right and left two inclined surfaces 917 and 918. As a result, the control unit that receives the detection signal from each of the sensors 7111 and 7112 drives each heating unit 7113 of each of the T-UFB generating apparatuses 700D and 700E. Consequently, the UFBs are generated from the heating units 7113 of all the T-UFB generating apparatuses 700A to 700E. Thereafter, with the driving of the heating units 7113 being continued, the UFB concentration of the water in the reserve chamber 901 is increased.

Additionally, in the T-UFB generating apparatuses 700A to 700E in this embodiment, when the T-UFBs are generated, the water near the heating unit 7113 is heated excessively, and the temperature is increased. Since the density of the water with high temperature is reduced relative to this increased temperature, upward convection occurs as indicated by arrows 9301 to 9305, and downward convection of the water with low temperature occurs relatively.

Thus, according to this embodiment, since the convection of the liquid in the reserve chamber 901 naturally occurs with the generation of the UFB-containing liquid, it is possible to obtain a uniform UFB concentration without providing a mechanism dedicated to agitating the water in the reserve chamber 901. Consequently, it is possible to achieve the simplification, downsizing, and cost-reduction of the device.

The convection of the water in this embodiment occurs with the T-UFB generating apparatuses being arranged in the positions as illustrated in FIG. 25. That is, in this embodiment, the T-UFB generating apparatuses are arranged on the surfaces except the upper surface 912, and this allows the above-described convection of the water to take place.

On the other hand, if the T-UFB generating apparatus is arranged on an upper surface portion of the liquid reserve container 900 to generate the UFBs from the heating unit in a horizontal state toward substantially immediately below for example, the convection of the water with high temperature does not occur, the water remains near the heating element, and the generation efficiency of the UFBs is reduced. This is because situations as below occurs:
the saturation solubility is reduced as the water has a high temperature; and
a bubble containing the UFBs that causes the precipitation of the gas already exists.

In other word, the UFB generation state that is similar to the UFB generation principle of the conventional Venturi method occurs, and thus the generation efficiency of the UFBs is reduced. However, since the T-UFB generating method itself functions, it is possible to generate the UFBs with higher concentration and higher efficiency than the conventional UFB generating method. However, in order to generate the UFBs more efficiently, like this embodiment, it is favorable that no T-UFB generating apparatus is arranged on a lower surface of the heating unit arranged horizontally, and the T-UFB generating apparatus is arranged in a direction other than horizontal so as to allow the convection of the water to take place.

Additionally, if the T-UFB generating apparatus is provided on a side surface and an inclined surface like this embodiment, it is advantageous to arrange the heating unit lower in terms of the convection. Moreover, in a case where the T-UFB generating apparatuses 700A to 700E are arranged, it is favorable to arrange the liquid detection sensor 7111 in a direction so as to be positioned higher in the direction of gravitational force than the heating unit 7113 as illustrated in FIG. 25. The reason of this is that, if the heating element is driven while no water exists, this increases the possibility that the heating element has an excessively high temperature and is degraded or damaged. If the liquid detection sensor 7111 is arranged on a higher portion than the heating unit 7113, it is possible to drive the heating unit 7113 while the water exists and to improve the life of the heating unit 7113.

### [Example of Application of T-UFB Generating Apparatus]

As can be clearly seen from the descriptions of the above-described embodiments, the T-UFB generating apparatus according to the present invention has the following advantages comparing with the conventional UFB generating apparatus.

There are advantages such as:
it is possible to generate a high UFB concentration;
it is possible to control the UFB generation amount and the generation speed;
it is possible to predict a UFB concentration to be generated since it is possible to control the UFB generation; and
it is possible to refill the consumed UFBs with high accuracy.

Therefore, as for the following products, it is also possible to improve the functions of the products by mounting the T-UFB generating apparatus according to the present invention therein. Hereinafter, there are listed examples of application of the T-UFB generating apparatus according to the present invention.

### <Aromatherapy Diffuser>

With the T-UFB generating apparatus according to the present invention being mounted in an aromatherapy diffuser, it is possible to switch and control the UFB concentration and the UFB generation speed depending on various usage situations, and the followings are achievable:

rapid UFB generation mode for preparation to have a visitor and the like;
low speed UFB generation mode for sleeping;
proper UFB generation speed switching depending on the type of aromatherapy oil;
evening out of the UFB concentration by combining with a detection unit for the UFB concentration in the atmosphere;
intra-diffuser cleaning function using UFBs at high concentration;
aromatherapy diffusing function using UFBs at low concentration;

and the like.

### <Shower>

With the T-UFB generating apparatus according to the present invention being mounted in a shower, it is possible to switch and control the UFB concentration and the UFB generation speed depending on various usage situations, and the followings are achievable:
switching of the UFB generation speed depending on temperature because of the difference in the saturation solubility of the gas between hot water and cold water;
switching of the UFB generation speed depending on flow speed;
switching of the UFB concentration depending on cleaning target;
intra-shower cleaning function using UFBs at relatively high concentration;
human body cleaning function using UFBs at relatively low concentration;

and the like.

### <Bathroom Cleaning Machine>

With the T-UFB generating apparatus according to the present invention being mounted in a bathroom cleaning machine, it is possible to switch and control the UFB concentration and the UFB generation speed depending on various usage situations, and the followings are achievable:
switching of the UFB generation speed depending on temperature because of the difference in the saturation solubility between hot water and cold water;
switching of the UFB generation speed depending on flow speed;
switching of the UFB concentration depending on cleaning target;
mold removing and pipe cleaning function using UFBs at relatively high concentration;
bathroom and bathtub cleaning function using UFBs at relatively low concentration;

and the like.

### <Toilet Cleaning Machine>

With the T-UFB generating apparatus according to the present invention being mounted in a toilet cleaning machine, it is possible to switch and control the UFB concentration and the UFB generation speed depending on various usage situations, and the followings are achievable:
switching of the UFB generation speed depending on temperature because of the difference in the saturation solubility between hot water and cold water;
switching of the UFB generation speed depending on flow speed;
switching of the UFB concentration depending on cleaning target;
water stain removing and pipe cleaning function using UFBs at relatively high concentration;
human body cleaning function using UFBs at relatively low concentration;

and the like.

### <Window Washer>

With the T-UFB generating apparatus according to the present invention being mounted in a window washer, it is possible to switch and control the UFB concentration and the UFB generation speed depending on various usage situations, and the followings are achievable:
switching of the UFB generation speed depending on liquid temperature or environment temperature because of the difference in the saturation solubility depending on temperature of a window washer liquid;
switching of the UFB generation speed depending on wiper speed;
switching of the UFB generation speed depending on moving speed of a vehicle because the liquid flows out to the outside of the window in shorter period of time as the moving speed of the vehicle is faster;
increase in the dust removing efficiency by increasing the UFB concentration in a case where the non-wiping period is long because dust is attached on the window if the wiping is not performed for a certain period of time;
switching of the UFB concentration depending on cleaning target such as, for example,
   water stain removing and pipe cleaning function using UFBs at relatively high concentration and
   wiping support in rainy weather using UFBs at relatively low concentration;

and the like.

### <Dish Cleaning Machine>

With the T-UFB generating apparatus according to the present invention being mounted in a dish cleaning machine, it is possible to switch and control the UFB concentration and the UFB generation speed depending on various usage situations, and the followings are achievable:
switching of the UFB generation speed depending on temperature because of the difference in the saturation solubility between hot water and cold water;
switching of the UFB generation speed depending on flow speed;
enabling cleaning with water at low temperature+UFBs at high concentration of also a dish of a material for which a dish cleaning machine cannot be used because a conventional dish cleaning machine can perform cleaning at only high temperature (example: plastic, coated item, and the like);
control of the UFB concentration depending on water properties such as hard water and soft water (control so as to generate UFBs at relatively high concentration for hard water in which water stain and the like occur frequently and generate UFBs at relatively low concentration for soft water, for example);
detergent-free mode in which UFBs at relatively high concentration is generated for a dish (material, coated item, and the like) for which it is improper to use a detergent;
metallic cooking equipment cleaning mode using UFB water at high temperature and high concentration;

and the like.

### <Coffee Maker>

With the T-UFB generating apparatus according to the present invention being mounted in a coffee maker, it is possible to switch and control the UFB concentration and the UFB generation speed depending on various usage situations, and the followings are achievable:
switching of the UFB generation speed depending on temperature because of the difference in the saturation solubility between hot water and cold water;
switching of the UFB generation speed depending on flow speed;
generation of UFBs at relatively high concentration for generating ice coffee that is diluted with ice;
generation of UFBs at relatively high concentration for generating cafe au lait that is mixed with milk;

and the like.

### <High-Pressure Cleaning Machine>

With the T-UFB generating apparatus according to the present invention being mounted in a high-pressure cleaning machine, it is possible to switch and control the UFB concentration and the UFB generation speed depending on various usage situations, and the followings are achievable:
switching of the UFB generation speed depending on temperature because of the difference in the saturation solubility between hot water and cold water;
switching of the UFB generation speed depending on flow speed;
detergent-free mode in which UFBs at relatively high concentration is generated for a dish (material, coated item, and the like) for which it is improper to use a detergent;
switching of the UFB concentration depending on water properties such as hard water and soft water;

and the like.

### <Food Cleaning Machine>

With the T-UFB generating apparatus according to the present invention being mounted in a food cleaning machine, it is possible to switch and control the UFB concentration and the UFB generation speed depending on various usage situations, and the followings are achievable:
switching of the UFB generation speed depending on temperature because of the difference in the saturation solubility between hot water and cold water;
switching of the UFB generation speed depending on flow speed;
raw meat and raw vegetable cleaning mode for reducing the change in quality of food by using UFBs at low temperature and high concentration;
dirt cleaning mode that gives priority to the cleaning effect by using UFBs at high temperature and high concentration;
cleaning mode for the cleaning machine itself using UFBs at high temperature and high concentration;

and the like.

### <Car Wash>

With the T-UFB generating apparatus according to the present invention being mounted in a car wash, it is possible to switch and control the UFB concentration and the UFB generation speed depending on various usage situations, and the followings are achievable:
switching of the UFB generation speed depending on temperature because of the difference in the saturation solubility between hot water and cold water;
switching of the UFB generation speed depending on flow speed;
detergent-free mode in which UFBs at relatively high concentration is generated for a vehicle body (material, coated item, and the like) for which it is improper to use a detergent;
cleaning mode for the car wash itself using UFBs at high temperature and high concentration;

and the like.

### <Medical Equipment Cleaning>

With the T-UFB generating apparatus according to the present invention being incorporated into medical equipment, or with medical equipment being connected to the T-UFB generating apparatus according to the present invention, it is possible to switch and control the UFB concentration and the UFB generation speed depending on various usage situations, and the medical equipment is applicable to the following devices.

(i) Application to Dental Medical Equipment
Internal cleaning of medical equipment with UFBs at relatively high concentration
Human body (oral cavity, teeth) cleaning with UFBs at relatively low concentration

(ii) Application to Surgery Assisting Robot
Internal cleaning of surgery equipment with UFBs at relatively high concentration
Human body (skin, organ) cleaning with UFBs at relatively low concentration
Adding of UFBs in a case where the UFB concentration is reduced in storage water or the like for organs and the like

(iii) Application to Endoscope
Internal cleaning of endoscope equipment with UFBs at relatively high concentration
Human body (inside of body, organ, blood vessel) cleaning with UFBs at relatively low concentration
Degerms and anti-bacterial treatment by coating an endoscope surface with UFB water when inserting the endoscope

### <Therapy Equipment>

With the T-UFB generating apparatus according to the present invention being incorporated into therapy equipment, or with therapy equipment being connected to the T-UFB generating apparatus according to the present invention, it is possible to switch and control the UFB concentration and the UFB generation speed depending on various usage situations, and the medical equipment is applicable to the followings:
generation of high concentration ozone nanobubble water for dental use (for removing biofilm generated on a cavity, for example);
generation of high concentration ozone UFB water for a water blister from burn injury;
stanching of an inner wall of a digestive organ (large intestine, small intestine, stomach, or the like) that is hurt by an endoscope and the like by using oxygen high concentration UFBs;
generation of a UFB concentration depending on age, sex, and condition of a patient;

and the like.

### <Water Pipe>

With the T-UFB generating apparatus according to the present invention being mounted in a water pipe, it is possible to switch and control the UFB concentration and the UFB generation speed depending on various usage situations including examples illustrated in FIGS. 21 and 22, and the followings are achievable:
switching of the UFB generation speed depending on temperature because of the difference in the saturation solubility between hot water and cold water;
switching of the UFB generation speed depending on flow speed;
chlorine-free water pipe using UFBs at high concentration;

and the like.

### <Water Cistern>

As for a water cistern provided in a rooftop and the like of complex housing such as an apartment, with the T-UFB generating apparatus according to the present invention being mounted therein, it is also possible to switch and control the UFB concentration and the UFB generation speed depending on various usage situations, and the followings are achievable:
UFB adding processing for changing the UFB concentration that is reduced due to a use by residents and adding of normal water to a predetermined UFB concentration;
UFB adding processing for changing the UFB concentration that is reduced in long-term storage to a predetermined UFB concentration;
chlorine-free water cistern using UFBs at high concentration;

and the like.

### <Low-Temperature Pasteurization Unit>

With the T-UFB generating apparatus according to the present invention being mounted in a low-temperature pasteurization device, it is possible to switch and control the UFB concentration and the UFB generation speed depending on various usage situations, and the followings are achievable:
pasteurization with UFB water at low temperature and high concentration (carbon dioxide-containing) for sake and shochu;
pasteurization with UFB water at low temperature and high concentration (nitrogen-containing) for wine;
proper UFB concentration depending on bactericidal concentration;
proper UFB concentration depending on brewing process;

and the like.

### <Fish Farming Unit>

With the T-UFB generating apparatus according to the present invention being mounted in a fish farming unit, it is possible to switch and control the UFB concentration and the UFB generation speed depending on various usage situations, and the followings are achievable:
UFB concentration depending on the type of fish;
control of growing speed by setting the UFB concentration depending on the growth of fish;
evening out of the UFB concentration by the UFB generation speed control depending on water temperature of the fishing farming unit;

and the like.

### <Food Storage Water>

With the T-UFB generating apparatus according to the present invention being mounted in a food storage water, it is also possible to switch and control the UFB concentration and the UFB generation speed depending on various usage situations, and the followings are achievable:
UFB concentration depending on the type of food;
control of the UFB generation speed by refilling the UFB concentration that is reduced during storage;
evening out of the UFB concentration by the UFB generation speed control depending on water temperature of the food storage water;

and the like.

### <Pearl Farming Unit>

With the T-UFB generating apparatus according to the present invention being mounted in a pearl farming unit, it is also possible to switch and control the UFB concentration and the UFB generation speed depending on various usage situations, and the followings are achievable:
UFB concentration depending on the type of pearl;
control of growing speed by setting the UFB concentration depending on the growth of pearl;
evening out of the UFB concentration by the UFB generation speed control depending on water temperature of the pearl farming unit;

and the like.

### <Carbonated Water Server>

With the T-UFB generating apparatus according to the present invention being mounted in a carbonated water server, it is possible to switch and control the UFB concentration and the UFB generation speed depending on various usage situations, and the followings are achievable:
UFB concentration depending on the type of carbonated water (hard water or soft water);
control of the UFB generation speed depending on flow rate of the carbonated water;
control of the UFB generation speed depending on water temperature of the carbonated water;

and the like.

### <Wafer Polishing Machine>

With the T-UFB generating apparatus according to the present invention being mounted in a wafer polishing machine, it is possible to switch and control the UFB concentration and the UFB generation speed depending on various usage situations, and the followings are achievable:
adding of UFBs at high concentration to polishing water;
control of the UFB concentration depending on a polishing target;
control of maintaining the UFB concentration constant by additionally generating UFBs that are reduced in the middle of polishing;

and the like.

### <Resist Stripping Unit on Wafer>

With the T-UFB generating apparatus according to the present invention being mounted in a resist stripping unit, it is possible to switch and control the UFB concentration and the UFB generation speed depending on various usage situations, and the followings are achievable:
generation of UFBs at high concentration for removing resist that is difficult to be stripped after implantation process;
control of the UFB concentration depending on the status of resist (degree of difficulty of stripping);
constant control of the UFB concentration by additionally generating UFBs reduced in the middle of stripping;

and the like.

### <Parts Cleaning Machine>

With the T-UFB generating apparatus according to the present invention being mounted in a parts cleaning machine, it is possible to switch and control the UFB concentration and the UFB generation speed depending on various usage situations, and the followings are achievable:
cleaning for removing contamination by using UFBs at high concentration in burring (grinder) process after pressing process;
control of the UFB concentration depending on material of the processing target;
control of the UFB concentration depending on the status, for example, before pressing process and after the process;

and the like.

### <Crack Repairing Unit for Building Member>

With the T-UFB generating apparatus according to the present invention being mounted in a crack repairing unit, it is possible to switch and control the UFB concentration and the UFB generation speed depending on various usage situations, and the followings are achievable:
processing of filling a hole with a reaction with a concrete member by leaving UFBs of carbon dioxide at high concentration after spraying;
control of the UFB concentration depending on the type of the concrete member;
control of the UFB concentration depending on the elapsed years from the manufacturing of the concrete member;
control of the UFB concentration depending on the original density of the concrete member;
processing of increasing and reducing the UFB concentration based on a degree of progress of repairing;

and the like.

<Automobile with High Combustion Efficiency>

With the T-UFB generating apparatus according to the present invention being mounted in an automobile, it is possible to switch and control the UFB concentration and the UFB generation speed depending on various usage situations, and the followings are achievable:
increase in the combustion efficiency by adding UFBs of highly concentrated oxygen into a fuel;
control of the UFB concentration depending on the selected gear;
control of the UFB concentration depending on temperature of the fuel;
control of the UFB concentration depending on the number of rotation of engine; and the like.

### <Bleaching Unit>

With the T-UFB generating apparatus according to the present invention being mounted in a bleaching unit, it is also possible to switch and control the UFB concentration and the UFB generation speed depending on various usage situations, and the followings are achievable:
improving processing for transparency of water by bleaching a pool (UFBs of highly concentrated ozone);
oxidization processing for iron by bleaching ground water (UFBs of highly concentrated oxygen);

and the like.

The present invention can be implemented with processing of supplying a program that implements one or more functions of the above-described embodiments to a system or a device through a network or a storage medium such that one or more processors in a computer of the system or the device reads and executes the program. Additionally, the present invention can also be implemented by a circuit that implements one or more functions (for example, ASIC).

The present invention is not limited to the above-described embodiments, and various changes and modifications are possible without departing from the spirit and the scope of the present invention. Therefore, the following claims are appended in order to specify the scope of the present invention.

1. An ultrafine bubble generating apparatus, comprising:
a heating unit that includes a heating element arranged in a position in contact with a liquid;
a driving unit that drives the heating unit to generate film boiling in the liquid and generates ultrafine bubbles; and
a control unit that controls driving conditions of the heating element by the driving unit.

2. The ultrafine bubble generating apparatus according to claim 1, wherein
the control unit controls as the driving conditions at least one of a driving frequency of the heating element, the number of the heating element to be driven out of plurality of the heating element included in the heating unit, and time for driving the heating element.

3. The ultrafine bubble generating apparatus according to claim 1, wherein
the control unit controls the driving conditions based on the number of ultrafine bubbles to be generated in the liquid.

4. The ultrafine bubble generating apparatus according to claim 1, wherein
the control unit controls the driving conditions based on a target concentration of ultrafine bubbles in the liquid.

5. The ultrafine bubble generating apparatus according to claim 1, wherein
the control unit controls the driving conditions based on a generation speed of ultrafine bubbles to be generated in the liquid.

6. The ultrafine bubble generating apparatus according to claim 1, further comprising:
an estimation unit that estimates generation time for generating a predetermined amount of an ultrafine bubble-containing liquid having a predetermined concentration based on the driving conditions.

7. The ultrafine bubble generating apparatus according to claim 6, further comprising:
a notifying unit that notifies of the generation time estimated by the estimation unit.

8. The ultrafine bubble generating apparatus according to claim 7, further comprising:
a concentration detection unit that detects a concentration of ultrafine bubbles in the liquid, wherein
the estimation unit updates the generation time based on the driving conditions and the concentration of ultrafine bubbles detected by the concentration detection unit during the generation of the ultrafine bubbles, and
the notifying unit notifies of the generation time updated by the estimation unit.

9. The ultrafine bubble generating apparatus according to claim 1, wherein
the control unit is able to stop the generation of ultrafine bubbles by stopping the driving of the heating element provided in the heating unit.

10. The ultrafine bubble generating apparatus according to claim 1, wherein
the heating unit is provided in a position in contact with a liquid flowing and moving through a predetermined liquid route.

11. The ultrafine bubble generating apparatus according to claim 10, wherein
the liquid route is formed of a circulation flow passage passing through a position in contact with the heating unit.

12. The ultrafine bubble generating apparatus according to claim 10, wherein
the liquid route allows the liquid in contact with the heating unit to flow out to a predetermined usage position.

13. The ultrafine bubble generating apparatus according to claim 10, further comprising:
a flow speed detection unit that detects a flow speed of the liquid in contact with the heating unit, wherein
the control unit controls the driving conditions based on the flow speed detected by the flow speed detection unit and the concentration of ultrafine bubbles in the liquid.

14. The ultrafine bubble generating apparatus according to claim 1, wherein
the heating unit is arranged in a position in contact with a liquid reserved in a reserve chamber of a liquid reserve container.

15. The ultrafine bubble generating apparatus according to claim 14, wherein
the heating unit is provided on at least one of a bottom surface and a side surface of the reserve chamber such that convection of the liquid reserved in the reserve chamber occurs due to heat generated by the heating element.

16. The ultrafine bubble generating apparatus according to claim 14, further comprising:
a liquid detection unit that detects the liquid in a position close to a higher portion of the heating unit in a direction of gravitational force, wherein
the control unit drives the heating element provided in the heating unit after the liquid detection unit detects the liquid.

17. The ultrafine bubble generating apparatus according to claim 12, wherein
the liquid route is a piping portion of a water pipe facility.

18. The ultrafine bubble generating apparatus according to claim 12, wherein
the liquid route is a water supply route that supplies water to a washing tub of a washing machine.

19. An ultrafine bubble generating method, comprising:
driving a heating element included in a heating unit to generate film boiling in a liquid in contact with the heating element, wherein
generation of ultrafine bubbles is controlled by controlling driving conditions of the heating element.

20. An ultrafine bubble-containing liquid that contains the ultrafine bubbles generated by the ultrafine bubble generating apparatus according to claim 1.

21. A non-transitory computer readable storage medium storing a program for causing a computer to execute a generating method for ultrafine bubbles in which a heating element included in a heating unit is driven to generate film boiling in a liquid in contact with the heating element, wherein
in the generating method,
generation of the ultrafine bubbles is controlled by controlling driving conditions of the heating element.
